(19) United States
(12) Patent Application Publication
(10) Pub. No.: US 2008/0166156 A1
(43) Pub. Date: Jul. 10, 2008

(54) Toner and method of manufacturing the same, two-component developer, developing apparatus, and image forming apparatus

(75) Inventor: Yoshitaka Kawase, Nara-shi (JP)

Correspondence Address: NIXON & VANDERHYE, PC, 901 NORTH GLEBE ROAD, 11TH FLOOR, ARLINGTON, VA, 22203, US

(73) Assignee: SHARP KABUSHIKI KAISHA, Osaka (JP)

(21) Appl. No.: 12/003,930

(22) Filed: Jan. 3, 2008

(30) Foreign Application Priority Data
Jan. 9, 2007 (JP) P2007-001796
Sep. 13, 2007 (JP) P2007-238473

(51) Int. Cl. G03G 15/06; G03G 9/087

(52) U.S. Cl. 399/222; 430/109.3; 430/137.13

(57) ABSTRACT

A toner excellent in temporal stability is provided which toner is capable of maintaining good cleaning property stably for a long period of time and whose surface is provided with a coating layer having an effect of preventing toner aggregation. There are also provided a method of manufacturing the toner, a two-component developer, a developing apparatus, and an image forming apparatus. The toner has a core particle containing a binder resin and a colorant and a coating layer which contains fine resin particles and are formed on surfaces of the core particles. The coating layers are formed by partially fusing the fine resin particles to at least either the core particle or adjacent fine resin particles.

### CROSS-REFERENCE TO RELATED APPLICATION

This application claims priority to Japanese Patent Application Nos. 2007-001796, which was filed on Jan. 9, 2007, and 2007-238473, which was filed on Sep. 13, 2007, the contents of which are incorporated herein by reference in its entirety.

### BACKGROUND OF THE INVENTION

1. Field of the Invention

The present invention relates to a toner for use in developing a latent image in an image forming apparatus which employs the electrophotographic or electrostatic printing system, and further, to a method of manufacturing the toner, a two-component developer, a developing apparatus, and an image forming apparatus.

2. Description of the Related Art

Toners for visualizing a latent image have been used in various image forming processes which include, as one known example, an electrophotographic image forming process.

An image forming apparatus for forming images through the electrophotographic system includes a photoreceptor, a charging section, an exposing section, a developing section, a transferring section, a fixing section, and a cleaning section. The charging section charges a surface of the photoreceptor. The exposing section irradiates the charged surface of the photoreceptor with signal light, thereby forming an electrostatic latent image corresponding to image information. The developing section supplies an electrophotographic toner (hereinafter often referred to simply as “a toner”) contained in a developer, to the electrostatic latent image formed on the surface of the photoreceptor drum so that a toner image is formed. The transferring section transfers the toner image formed on the surface of the photoreceptor onto the recording medium. The fixing section fixes the transferred toner image to the recording medium. The cleaning section is, for example, a cleaning blade which scrapes off a toner remaining on the surface of the photoreceptor, thus cleaning the surface of the photoreceptor. In the image forming apparatus as just described, an image is formed by developing an electrostatic latent image with use of a developer which is one-component developer containing a toner or two-component developer containing a toner and a carrier. The toner herein is made of resin particles which are obtained by granulation of a colorant, wax serving as a release agent, and the like ingredient dispersed in a binder resin serving as a matrix.

Through the electrophotographic image forming apparatus, an image having favorable image quality can be formed at high speed and low cost. This promotes the use of the electrophotographic image forming apparatus in a copier, a printer, a facsimile, or the like machine, resulting in a remarkable spread thereof in recent years. Simultaneously, the image forming apparatus has faced up to more demanding requirements. Among such requirements, particular attentions are directed to enhancement in definition and resolution, stabilization of image quality, and an increase in image forming speed, regarding an image being formed by the image forming apparatus. In order to fulfill these demands, a two-way approach is indispensable in view of both the image forming process and the developer.

From the aspect of the developer, it is important to prevent a decrease in image density and a rise of the image fogging in order to enhance the image quality. From this perspective, a problem to be solved is directed to the prevention of defective cleaning resulting from the toner attached to the photoreceptor and the prevention of toner filming that a component of the toner is firmly adhered to the photoreceptor. With the aim of solving such a problem as above, there has been proposed a toner which is intended to improve the cleaning property.

The publication of JP-B2 2-3172 (1990) discloses a toner which is obtained by mixing toner particles and fine particles smaller in average diameter than the toner particles. In the toner, the fine particles are attached to the toner particles. The fine particles in JP-B2 2-3172 are polymer fine particles which are substantially spherical and whose average diameter falls in a range from 0.05 μm to 5 μm. The polymer fine particles are obtained with the aid of a persulfate series-initiator or with the use of a water-soluble polymer instead of emulsifier, by polymerizing in an aquatic medium, one or more monomers selected from acrylic ester monomers, methacrylic ester monomers, styrene monomers, nitrogen-containing addition-polymerizable monomers, and polymerizable unsaturated carboxylic monomers.

Japanese Unexamined Patent Publication JP-A 3-100660 (1991) discloses a color toner in which resin fine powders are firmly adhered to surfaces of spherical toner particulate powders having an average diameter of 2 μm to 8 μm. The resin fine powders have an average diameter of 50 μm to 150 μm with a glass transition temperature higher than that of a binder resin contained in the toner particulate powders.

Japanese Examined Patent Publication JP-B2 3365018 discloses a toner which is obtained by treating surfaces of toner particles so as to fix thereto organic fine particles having higher hardness than a binder resin of the toner particles, followed by an external addition of fine particles for aftertreatment. In JP-B2 3365018, an amount of the added organic fine particles is 0.5% by weight to 3% by weight based on that of the toner particles, and primary particles are 0.01 μm to 2 μm in average diameter and higher in Rockwell hardness than the a binder resin by 10 or more.

Japanese Unexamined Patent Publication JP-A 10-307424 (1998) discloses a toner in which chargeable resin particles are firmly adhered to surfaces of nonspherical particles containing a colorant and a binder resin. In JP-A 10-307424, a surface coverage of the nonspherical particles with the chargeable resin particles is in a range of from 5% to 50%. In addition, the chargeable resin particles firmly adhered to the nonspherical particles are fused mutually on convex surfaces of the nonspherical particles.

In the toners disclosed in the above related art, the organic fine particles are attached, firmly adhered, or fused to the toner particles, which allows for improvement in cleaning property of the toner and thus enables to prevent toner filming. The toners disclosed in the above related art however accompany the following problems to be solved.

In the toner disclosed in JP-B2 2-3172, the fine powders are mixed with the toner particles so that the fine powders are attached to the toner particles. In this state, adherence of the fine powder to the toner particles is so small that when the toner is used for a long term, the fine particles are desorbed from the toner particles, for example, by agitating the developer inside a developer container, thus causing difficulty in maintaining for a long time an effect of improved cleaning property owing to the mixing of the fine particles.

In the toners disclosed in JP-A 3-100660 and JP-B2 3365018, the resin fine powders or organic resin fine particles (hereinafter referred to collectively as “resin fine particles”) are buried in the toner particles, as being firmly adhered thereto, attributable to mechanical impact caused by, for example, a commonly-used mixer or a hybridization system. The toners disclosed in JP-A 3-100660 and JP-B2 3365018 are higher in adherence of the resin fine particles to the toner particles compared to the case of the toner disclosed in JP-B2 2-3172. In the toners disclosed in JP-A 3-100660 and JP-B2 3365018, however, the resin fine particles cannot be sufficiently prevented from being desorbed from the toner particles upon agitating the developer inside the developer container, thus failing to solve the problem of decrease in cleaning property for a long-term use.

In the toner disclosed in JP-A 10-307424, the chargeable resin particles are fused to be fixed on the nonspherical particles, therefore allowing for a sufficient increase in adherence of the chargeable resin particles to the nospherical particles. In the toner disclosed JP-A 10-307424, however, the surface coverage of the nonspherical particles with the chargeable resin particles is 5% to 50% and in addition, the chargeable resin particles are firmly adhered to only the convex surfaces of the nonspherical particles, incurring a problem that low melting point components contained in the nonspherical particles leach out to cause the toner to aggregate.

Moreover, a toner has been recently desired to have a lower fixing temperature along with tendencies of higher process speed and more energy conservation. As a method of manufacturing a toner adapted for fixing at low temperature, there has been proposed a method of adding crystalline polyester having a low melting point. In the method, the crystalline polyester resin easily causes blocking of toner powders and it is thus difficult to maintain the storage stability. Furthermore, it is also difficult to maintain the storage stability of fixed toner image.

A capsule toner has been also proposed whose surface is coated with a resin layer, in response to a design demand of a toner that exhibits a uniform electrification performance and is excellent in fluidity, transferring property, anti-offset property, and anti-tracking property, with various other functions.

The toner disclosed in Japanese Unexamined Patent Publication JP-A 2006-91379 is manufactured by applying amorphous resin onto surfaces of core particles composed of crystalline polyester resin and a colorant which have prescribed melting points and weight average molecular weights, while suppressing volume contraction resulting from rapid cooling.

Japanese Unexamined Patent Publication JP-A 2007-93809 discloses a toner which has a core-shell structure that shells are provided on surfaces of core particles containing a composite resin and a colorant fine particles. The composite resin is obtained by binding crystalline polyester resin and styrene resin to polyester resin. To be more specific, the toner is manufactured in a manner that core aggregated particles are formed in dispersion containing the fine particles, and shell resin fine particles are attached to surfaces of the core aggregated particles, followed by integration of obtained core-shell particles.

In forming the core-shell structure of capsule toner mentioned above, it is difficult to form a uniform core-shell bonded interface. Strength of core-shell interface in the capsule toner of conventional design has not reached to a sufficient level. Without sufficient interface strength, a shell layer may flake away and further, a core layer may be scraped off, thereby generating fine particles which will be firmly adhered to surfaces of carriers. This accelerates deterioration of chargeability of the developer. Moreover, such generated fine particles will easily move to a developing roll, a photoreceptor, the carrier, and the like component. There has been therefore concern that the developing roll, the photoreceptor, and the carrier are more easily contaminated, which leads to a decrease in quality of formed images.

### SUMMARY OF THE INVENTION

An object of the invention is to provide a toner excellent in temporal stability, which is capable of maintaining good cleaning property stably for a long period of time and whose surface is provided with a coating layer having an effect of preventing toner aggregation. Another object of the invention is to provide a method of manufacturing the toner just stated. Still another object of the invention is to provide a two-component developer, a developing apparatus, and an image forming apparatus, which employ the toner stated above.

The invention provides a toner comprising:

a core particle containing a binder resin and a colorant; and

a coating layer formed on a surface of the core particle, containing fine resin particles, the fine resin particles being partially fused to at least either the core particle or adjacent fine resin particles.

According to the invention, the coating layer containing fine resin particles is formed on the surface of the core particle containing a binder resin and a colorant. The fine resin particles are partially fused to at least either the core particle or adjacent fine resin particles, thereby forming the coating layer. The coating layer as just described can be prevented from being desorbed from the core particle, for example, upon agitating the developer inside a developer container, thanks to the fine resin particles fused to the core particle. As a result, the coating layer enables to prevent an electrophotographic toner (hereinafter referred to simply as “toner”) from changing in property in the course of long-term use. Moreover, a tiny protrusion is formed on the surface of the coating layer since the fine resin particles are fused not entirely but in part to at least either the core particle or the adjacent fine resin particles. Owing to the tiny protrusion, the toner is easily caught by a cleaning blade, thereby enhancing the cleaning property. In the case where the coating layer is formed on an entirety or most part of the surface of the core particle, appropriate selection of a favorable material for the fine resin particles prevents the toner from aggregating, thus allowing for a toner excellent in temporal stability.

Further, the fine resin particles are fused to at least a part of the adjacent fine resin particles, being thus unified to form a solid coating layer while a plurality of the fine resin particles are fused also to the surface of the core particle so that the core particle and the coating layer are firmly adhered to each other. A toner thus obtained therefore contains the solid coating layer which is firmly adhered to the core particle. Since an individual fine resin particle is fused in plural parts to other fine resin particles, the fine resin particles are less likely to be desorbed from the coating layer. In addition, the coating layer is fused in so many parts to the core particle and therefore, the coating layer is less likely to be desorbed from the core particle.

Further, in the invention, it is preferable that a ratio of a surface area of the core particle where the coating layer is formed is 80% to 100% of an entire surface area of the core particle.

According to the invention, the coating layer formed on the core particle covers 80% to 100% of the entire surface area of the core particle and therefore, low melting point components are prevented from leaching out, for example, thus resulting in better storage stability of the toner. In addition, the core particle and the coating layer are fused to each other and therefore hard to be detached from the surface of the toner, thus exhibiting excellent temporal stability.

Further, in the invention, it is preferable that a ratio A/B is 0.01 to 0.2 where A represents an average particle size of fused fine resin particles contained in the coating layer and B represents an average particle size of the core particle.

According to the invention, the ratio A/B is 0.01 to 0.2 where A represents the average particle size of the fused fine resin particles contained in the coating layer and B represents the average particle size of the core particles. The average particle size A of the fused fine resin particles in the coating layers is an average value of lengths of major axis and minor axis of the fine resin particles which are partially fused, when viewed from the surfaces of the coating layers. The average particle size B of the core particles is an average value of lengths of major axis and minor axis of the core particles when viewed in one direction. When the ratio A/B is 0.01 to 0.2 where A represents the average particle size of the fine resin particles and B represents the average particle size of the core particles, a thickness of the coating layer can be set at a favorable level, which enables to prevent the coating layer from being ruptured upon agitating the developer inside the developer container, while the fine resin particle-containing coating layers can be formed over the whole or large part of the core particles. In addition, a height of the protrusion can be set at a favorable level. This enables to more stably prevent for a long period of time the toner from being denatured, and moreover to enhance the cleaning property.

Further, in the invention, it is preferable that the fine resin particles include acrylic resin, styrene-acryl copolymer resin, or polyester resin.

According to the invention, the fine resin particles include acrylic resin, styrene-acryl copolymer resin, or polyester resin. The resin just listed is favorable with many advantages such as being lightweight, strong, high in transparency, and inexpensive.

Further, in the invention, it is preferable that the core particle includes a binder resin containing at least crystalline polyester resin and amorphous polyester resin, a colorant, and a release agent.

According to the invention, the core particle includes a binder resin containing at least crystalline polyester resin and amorphous polyester resin, a colorant, and a release agent. In the constitution as just stated, even an increase of the low-softening component contained in the toner does not cause the low-softening component to be exposed on the surface of the toner, leading to an increase in surface hardness without impairing the fixing property and thus allowing for enhancement in storage stability and mechanical strength.

Further, the invention provides a method of manufacturing the above-mentioned toner, the method comprising bringing the core particle and fine resin particles into contact with each other in a presence of an adhering aid for increasing adherence between the core particle and the fine resin particles.

According to the invention, the toner having the above-stated effects is manufactured by bringing the core particle and the fine resin particles into contact with each other in the presence of the adhering aid which increases the adherence between the core particle and the fine resin particles. For example, the adhering aid increases the adherence between the core particle and the fine resin particles by enhancing the wettability of the fine resin particles to the core particle. The use of such an adhering aid makes it easy to form the fine resin particle-containing coating layer over the whole or large part of the core particle. The coating layer thus obtained is hard to be desorbed from the core particle owing to the presence of the fine resin particles fused to the core particle. This enables to prevent the toner from changing in property resulting from the detachment of the coating layer in the course of long-term use. Moreover, some parts of toner where the fine resin particles covering the core particle are not fused, will form a tiny protrusion on the surface of the coating layer, so that the toner is easily caught by a cleaning blade, thereby allowing for enhancement in the cleaning property of the toner.

Further, in the invention, it is preferable that a volume average particle size of fine resin particles before fusion is 0.05 μm to 0.5 μm.

According to the invention, the volume average particle size of the fine resin particles before fusion is 0.05 μm to 0.5 μm, enabling to set at a favorable level the average particle size A of the protrusion which is formed of the fine resin particles fused to the core particle or the adjacent fine resin particles, with the result that the cleaning property can be further enhanced.

Further, in the invention, it is preferable that the adhering aid includes water or lower alcohol.

According to the invention, the adhering aid includes water or lower alcohol. The use of these materials as the adhering aids can enhance the wettability of the fine resin particles to the core particle, thus making it easier to form the fine resin particle-containing coating layers over the whole or large part of the surface of the core particle. Moreover, in this case, it is possible to shorten a drying time necessary to remove the adhering aid.

Further, in the invention, it is preferable that the fine resin particles are used at a ratio of 1 part by weight to 30 parts by weight based on 100 parts by weight of the core particles.

According to the invention, the fine resin particles are used at a ratio of 1 part by weight to 30 parts by weight based on 100 parts by weight of the core particles. The use of the fine resin particles in such a ratio enables the fine resin particles to be attached to the whole surfaces of the core particles so that the coating layers can be formed over the entire surfaces of the core particles. This can more certainly prevent the toner aggregation resulting from leaching of the low melting point components contained in the core particles.

Further, in the invention, it is preferable that the fine resin particles are attached and fused to the core particle by a surface-modifying apparatus which comprises: a container for housing the core particle and the fine resin particles; an atomizer for atomizing the adhering aid into the container; and an agitator for agitating the core particle inside the container.

According to the invention, the fine resin particles are attached and fused to the core particles by the surface-modifying apparatus which comprises: the container for housing the core particles and the fine resin particles; the atomizer for atomizing the adhering aid into the container; and the agitator for agitating the core particles inside the container. In the method as just mentioned, the fine resin particles can be attached evenly to the core particles with the aid of the adhering aid, allowing for a toner which is uniform in property such as chargeability. Moreover, using the surface-modifying apparatus, the use ratio between the core particles and the fine resin particles can be easily set, and the thickness of the coating layer can be set at a favorable level.

Further, in the invention, it is preferable that the fine resin particles are attached and fused to the core particles by a surface-modifying apparatus which comprises: a container for housing the core particle; an atomizer for atomizing a mixture of the fine resin particles and the adhering aid into the container; and an agitator for agitating the core particles inside the container.

According to the invention, the fine resin particles are attached and fused to the core particles by the surface-modifying apparatus which comprises: the container for housing the core particles; the atomizer for atomizing the mixture of the fine resin particles and the adhering aid into the container; and the agitator for agitating the core particles inside the container. Also in the method as just mentioned, the fine resin particles can be attached evenly to the core particles with the aid of the adhering aid, allowing for a toner which is uniform in property such as chargeability. Moreover, it is easy to fuse the fine resin particles evenly to the core particles.

Further, in the invention, it is preferable that the adhering aid is used at a ratio of 1 part by weight to 99 parts by weight based on 1 part by weight of the fine resin particles.

According to the invention, the ratio of the adhering aid is used at a ratio of 1 part by weight to 99 parts by weight based on 1 part by weight of the fine resin particles. In the case where the fine resin particles and the adhering aid are mixed and atomized by one atomizer, the use of the mixture containing the fine resin particles and the adhering aid in the above ratio can sufficiently enhance the wettability of the fine resin particles to the core particle and moreover shorten the time necessary to remove the adhering aid. Further, in this case, the mixture has such favorable viscosity as to be easily atomized by the atomizer.

Further, in the invention, it is preferable that a temperature inside the container is less than a glass transition temperature of the binder resin contained in the core particle.

According to the invention, the temperature inside the container is less than the glass transition temperature of the binder resin contained in the core particles, which enables to prevent the core particle aggregation caused by excessive fusion of the core particles inside the container in manufacturing the toner.

Further, in the invention, it is preferable that the adhering aid is atomized in a state where the core particle is suspended inside the container.

According to the invention, the mixture of the fine resin particles and the adhering aid is atomized in the state where the core particles are suspended inside the container. This can shorten a length of time that the core particles coated with the atomized adhering aid are in contact with each other, and moreover prevent the toner aggregation so as not to generate coarse particles in manufacturing the toner, which enables to obtain a toner made of particles uniform in size.

Further, the invention provides a two-component developer comprising the toner and a carrier.

According to the invention, the toner of the invention is mixed with the carrier to thereby form the two-component developer which can maintain a stable electrification performance.

Further, the invention provides a developing apparatus which perform a developing operation with use of the two-component developer.

According to the invention, the use of the developing apparatus employing the developer of the invention for the developing operation can stably form toner images on a photoreceptor.

Further, the invention provides an image forming apparatus comprising the developing apparatus.

According to the invention, the use of the image forming apparatus for forming images with use of the developing apparatus of the invention can form stable images which are high in reproducibility.

### BRIEF DESCRIPTION OF THE DRAWINGS

Other and further objects, features, and advantages of the invention will be more explicit from the following detailed description taken with reference to the drawings wherein:

FIG. 1 is a flowchart showing a procedure of a method of manufacturing a toner according to one embodiment of the invention;

FIG. 2 is a cross-sectional view schematically showing a configuration of an image forming apparatus according to the invention; and

FIG. 3 is a cross-sectional view schematically showing a configuration of a developing section according to the invention.

### DETAILED DESCRIPTION

Now referring to the drawings, preferred embodiments of the invention are described below.

A toner of the invention contains core particles and coating layers formed on surfaces of the core particles. The core particles contain a binder resin and a colorant. The coating layers contain fine resin particles, and the fine resin particles are partially fused to at least either the core particles or adjacent fine resin particles.

The coating layers are formed on the surfaces of the core particles. In the case where the coating layers are partially formed on the surfaces of the core particles, it is preferable that the coating layers be formed on a large part of the surfaces of the core particles. The large part of the surfaces of the core particles indicates a part covering 80% or a larger percent of the entire surface area of the respective core particles. When the area of core particles covered with the coating layers is less than 80% of the entire surface area of the respective core particles, an exposed area of core particles is large, which may cause low melting point components contained in the core particles to be softened and thus lead to toner aggregation. Accordingly, a ratio of the area of the respective core particles covered with the coating layers is preferably 80% to 100%, and more preferably 90% to 100%, of the entire surface area of the respective core particles. The entire surface area of the core particles can be determined by measuring a volume average particle size of the core particles based on an assumption that the core particles are spherical. The area of core particles covered with the coating layers can be determined from an electron micrograph by use of an image analyzing apparatus. In the case where the coating layers are formed over the large part of the surfaces of the core particles, an obtained effect is almost the same as the effect obtained in the case where the coating layers are formed over the entire surfaces of the core particles. The latter case is therefore taken as an example and will be described hereinbelow.

In the toner of the invention, there exist the fine resin particles fused to the core particles, which can prevent the detachment of the coating layers from the core particles caused by, for example, agitating of the developer inside the developer container. This enables to prevent the toner from changing in property in the course of long-term use. Moreover, a tiny protrusion is formed on the surface of the coating layer since the fine resin particles are fused not entirely but in part to at least either the core particles or the adjacent fine resin particles. Owing to the tiny protrusion, the toner is easily caught by a cleaning blade, thereby enhancing the cleaning property. In the case where the coating layer is formed on the entire surfaces of the core particles, appropriate selection of a favorable material for the fine resin particles prevents the toner from aggregating, thus enabling to obtain a toner which exhibits excellent temporal stability.

Further, in the toner of the invention, a ratio A/B is preferably 0.01 to 0.2 where A represents an average particle size of the fused fine resin particles contained in the coating layers and B represents an average particle size of the core particles. The average particle size A of the fused fine resin particles in the coating layers is an average value of lengths of major axis and minor axis of the fine resin particles which are partially fused, when viewed from the surfaces of the coating layers. The average particle size B of the core particles is an average value of lengths of major axis and minor axis of the core particles when viewed in one direction.

The average particle size A of the fused fine resin particles depends on a volume average particle size of fine resin particles before fusion. The volume average particle size of the fine resin particles before fusion and the average particle size A of the fused fine resin particles may be very different from each other according to the fused state of fine resin particles. For this reason, the average particle size A of the invention indicates an average particle size of the fine resin particles which have already formed the coating layers, namely an average particle size of partially-fused fine resin particles. In the following descriptions, “the average particle size A of the fused fine resin particles” will be sometimes referred to as “average particle size A of the protrusion”.

The average particle size A of the protrusion is determined in the following manner. For example, a toner having a coating layer is photographed at 10,000-fold magnification by an electron microscope: VE-9800 (trade name) manufactured by Keyence Corporation. During photography of the toner, a plurality of, for example, five circles with radius 1.5 μm (which appear as 1.5 cm in the electron micrograph of the toner) are located in the micrograph. The average particle size A is determined by measuring the fused fine resin particles present within the located circles. A plurality of partially-fused fine resin particles form a plurality of protrusions on the surface of the coating layer. Among a plurality of the protrusions within the located circles, one protrusion is selected. Recesses which form the selected protrusion are connected to each other by a straight line which passes through a center of the fine resin particle. A length of the straight line is measured, and will be hereinafter referred to as “recess-to-recess distance”. The center of the fine resin particle is the most convex part of the protrusion, which is determined with eyes, for example. Among lengths of obtained recess-to-recess distances which recesses form the protrusions, the shortest distance is defined as a minor axis A1 of the protrusion while the longest distance is defined as a major axis A2 of the protrusion. An average value of the minor axis A1 and the major axis A2, that is, an average diameter (A1+A2)/2 is obtained. Furthermore, the average diameter is obtained for each protrusion among a plurality of the protrusions within a plurality of the circles, and an average value of the average diameters thus obtained is calculated. A resultant value thus calculated is determined as an average particle size A of the protrusion, that is, an average particle size A of the fused fine resin particles contained in the coating layer.

An average particle size B of the core particles is determined in the following manner. For example, the core particles are photographed at 5,000-fold magnification by the above-specified electron microscope. From an electron micrograph thus obtained, a minor axis B1 and a major axis B2 are measured and an average value of the minor axis B1 and the major axis B2, that is, an average diameter (B1+B2)/2 is obtained. A resultant value thus obtained is determined as an average particle size B of the core particles.

When a ratio A/B is 0.01 to 0.2 where A represents the average particle size of the fine resin particles determined in the above manner and B represents the average particle size of the core particles determined in the above manner, a thickness of the coating layer can be set at a favorable level. The thickness of the coating layer can be determined based on a difference in particle size between the core particle and the toner having the coating layer. With the coating layer having a favorable thickness, the coating layer can be prevented from being ruptured upon agitating the developer inside the developer container and moreover, the coating layer containing the fine resin particles can be formed over the entire surfaces of core particles. When the above-mentioned ratio A/B is 0.01 to 0.2, the tiny protrusions formed of the fine resin particles can be dimensioned favorably. This enables to more stably prevent for a long period of time the toner from being denatured, and moreover to maintain the cleaning property.

When the above-mentioned ratio A/B is less than 0.01, the thickness of the coating layer is small as compared to the average particle size B of the core particles, which may cause the coating layer to be ruptured upon agitating the developer inside the developer container and therefore cause the toner to fail to exhibit the temporal stability. When the above-mentioned ratio A/B exceeds 0.2, the fine resin particles yet to form the coating layer are large in particle size as compared to the average particle size B of the core particles, which makes it difficult to fuse the fine resin particles and the core particles to each other and to mutually fuse the fine resin particles. Such difficulties of the fine resin particle-to-core particle fusion and the fine resin particle-to-fine resin particle fusion may cause a failure to form the fine resin particle-containing coating layers over the entire surfaces of the core particles.

The toner of the invention contains a binder resin, a colorant, and other toner additive components. The other toner additive components include a release agent and a charge control agent, for example. In the following description, a method of manufacturing the toner of the invention will be explained. The toner of the invention is manufactured, for example, by attaching and fusing the fine resin particles to the core particles with use of an adhering aid for increasing adherence between the core particles and the fine resin particles.

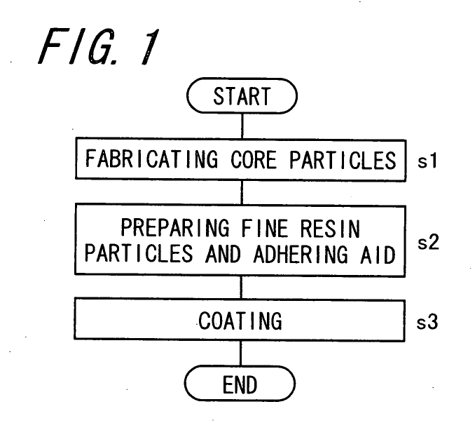

FIG. 1 is a flowchart showing a procedure of a method of manufacturing a toner according to one embodiment of the invention. The method of manufacturing the toner according to the present embodiment includes Step s1 of fabricating the core particles, Step s2 of preparing the fine resin particles and the adhering aid, and Step s3 of coating. Note that Step s1 of fabricating the core particles and Step s2 of preparing the fine resin particles and the adhering aid may be temporally replaced with each other.

(Step of Fabricating Core Particles)

At Step s1 of fabricating the core particles, the core particles containing the binder resin and the colorant are fabricated. The core particles used for the toner of the invention contain the binder resin and the colorant, and may further contain a release agent, a charge control agent, etc.

A selection of material for the binder resin is not particularly limited as long as the material customarily serves as a binder resin for use in a toner. Such materials include, for example, polyester, polyurethane, epoxy resin, acrylic resin, and styrene-acryl resin, among which polyester, acrylic resin, and styrene-acryl resin are preferred. The resin just cited may be used alone, or two or more thereof may be used in combination. Moreover, the resin of the same sort which is different in either one or a plurality of molecular weight, monomer composition, etc. may be used in combination.

Polyester is excellent in transparency and capable of providing aggregated particles with favorable powder fluidity, a low-temperature fixing property, secondary color reproducibility, and the like property. Polyester is thus favorable for use in a color toner. As polyester, known ingredients can be used including polycondensation of polybasic acid and polyhydric alcohol.

As polybasic acid, those known as monomers for polyester can be used including, for example: aromatic carboxylic acids such as terephthalic acid, isophthalic acid, phthalic acid anhydride, trimellitic acid anhydride, pyromellitic acid, and naphthalene dicarboxylic acid; aliphatic carboxylic acids such as maleic acid anhydride, fumaric acid, succinic acid, alkenyl succinic anhydride, and adipic acid; and a methyl-esterified compound of these polybasic acids. These polybasic acids may be used each alone, or two or more of the polybasic acids may be used in combination.

As polyhydric alcohol, those known as monomers for polyester can also be used including, for example: aliphatic polyhydric alcohols such as ethylene glycol, propylene glycol, butane diol, hexane diol, neopentyl glycol, and glycerin; alicyclic polyhydric alcohols such as cyclohexane diol, cyclohexane dimethanol, and hydrogenated bisphenol A; and aromatic diols such as an ethylene oxide adduct of bisphenol A and a propylene oxide adduct of bisphenol A. These polyhydric alcohols may be used each alone, or two or more of the polyhydric alcohols may be used in combination.

Polycondensation reaction of polybasic acid and polyhydric alcohol can be effected in a common manner. For example, the polycondensation reaction is effected by contacting polybasic acid and polyhydric alcohol each other in the presence or absence of an organic solvent and under the presence of a polycondensation catalyst, and terminated at the instant when the acid value and the softening temperature of the resultant polyester stand at predetermined values. Polyester is thus obtained. In the case of using the methyl-esterified compound of polybasic acid as a part of polybasic acid, a de-methanol polycondensation reaction takes place. In the polycondensation reaction, by properly changing the blending ratio, the reaction rate, or other factors as to the polybasic acid and the polyhydric alcohol, it is possible to adjust, for example, the terminal carboxyl group content of polyester and thus denature a property of the resultant polyester. Further, when trivalent or higher valent polybasic acid such as trimellitic anhydride is used as polybasic acid, a carboxyl group can be easily introduced into a main chain of polyester, resulting in denatured polyester. Also usable is polyester having hydrophilic radical such as carboxyl group and sulfonate group bonded to a main chain and/or a side chain. Further, polyester may be grafted with acrylic resin.

Other than polyester stated above, crystalline polyester may be used. As crystalline polyester, heretofore known ingredients can be used, including polycondensation of polybasic acid and polyhydric alcohol. The polybasic acid components include, for example, aliphatic dicarboxylic acids such as oxalic acid, succinic acid, glutaric acid, adipic acid, suberic acid, azelaic acid, and sebacic acid; aromatic dicarboxylic acids such as dibasic acids represented by phthalic acid, isophthalic acid, and terephthalic acid; and anhydride and lower alkyl ester of those ingredients just cited. The polybasic acid components may be used each alone, and two or more thereof may be used in combination.

As the acrylic resin, the selection of ingredients is not particularly limited, and acidic group-containing acrylic resin can be preferably used. The acidic group-containing acrylic resin can be produced, for example, by polymerization of acrylic resin monomers or polymerization of an acrylic resin monomer and a vinylic monomer with concurrent use of acidic group- or hydrophilic group-containing an acrylic resin monomer and/or acidic group- or hydrophilic group-containing a vinylic monomer.

As the acrylic resin monomer, heretofore known ingredients can be used, including acrylic acid which may have a substituent, methacrylic acid which may have a substituent, acrylic acid ester which may have a substituent, and methacrylic acid ester which may have a substituent. Specific examples of the acrylic resin monomer include: monomers of acrylic esters such as methyl acrylate, ethyl acrylate, isopropyl acrylate, n-butyl acrylate, isobutyl acrylate, n-amyl acrylate, isoamyl acrylate, n-hexyl acrylate, 2-ethylhexyl acrylate, n-octyl acrylate, decyl acrylate, and dodecyl acrylate; monomers of methacrylic esters such as methyl methacrylate, propyl methacrylate, n-butyl methacrylate, isobutyl methacrylate, n-amyl methacrylate, n-hexyl methacrylate, 2-ethylhexyl methacrylate, n-octyl methacrylate, decyl methacrylate, and dodecyl methacrylate; and hydroxyl group-containing monomers of (meth)acrylic esters such as hydroxyethyl acrylate and hydroxypropyl methacrylate. The acrylic resin monomers may be used each alone, or two or more of the acrylic resin monomers may be used in combination.

Moreover, as the vinylic monomer, heretofore known ingredients can be used, including styrene, α-methylstyrene, vinyl bromide, vinyl chloride, vinyl acetate, acrylonitrile, and methacrylonitrile. These vinylic monomers may be used each alone, or two or more of the vinylic monomers may be used in combination. The polymerization is effected by use of a commonly-used radical initiator in accordance with a solution polymerization method, a suspension polymerization method, an emulsification polymerization method, or the like method.

The styrene-acryl resin includes, for example, a styrene-acrylic acid methyl copolymer, a styrene-acrylic acid ethyl copolymer, a styrene-acrylic acid butyl copolymer, a styrene-methacrylic acid methyl copolymer, a styrene-methacrylic acid ethyl copolymer, a styrene-methacrylic acid butyl copolymer, and a styrene-acrylonitrile copolymer.

It is preferred that the binder resin have a glass transition temperature of 30° C. to 80° C. The binder resin having a glass transition temperature lower than 30° C. easily causes the blocking that the toner thermally aggregates inside the image forming apparatus, which may lead to a decrease in storage stability. The binder resin having a glass transition temperature higher than 80° C. lowers the fixing property of the toner onto a recording medium, which may cause a fixing failure.

As the colorant, it is possible to use an organic dye, an organic pigment, an inorganic dye, and an inorganic pigment, which are customarily used in the electrophotographic field.

Black colorant includes, for example, carbon black, copper oxide, manganese dioxide, aniline black, activated carbon, non-magnetic ferrite, magnetic ferrite, and magnetite.

Yellow colorant includes, for example, yellow lead, zinc yellow, cadmium yellow, yellow iron oxide, mineral fast yellow, nickel titanium yellow, navel yellow, naphthol yellow S, hanza yellow G, hanza yellow 10G, benzidine yellow G, benzidine yellow GR, quinoline yellow lake, permanent yellow NCG, tartrazine lake, C.I. pigment yellow 12, C.I. pigment yellow 13, C.I. pigment yellow 14, C.I. pigment yellow 15, C.I. pigment yellow 17, C.I. pigment yellow 93, C.I. pigment yellow 94, and C.I. pigment yellow 138.

Orange colorant includes, for example, red lead yellow, molybdenum orange, permanent orange GTR, pyrazolone orange, vulcan orange, indanthrene brilliant orange RK, benzidine orange G, indanthrene brilliant orange GK, C.I. pigment orange 31, and C.I. pigment orange 43.

Red colorant includes, for example, red iron oxide, cadmium red, red lead oxide, mercury sulfide, cadmium, permanent red 4R, lysol red, pyrazolone red, watching red, calcium salt, lake red C, lake red D, brilliant carmine 6B, eosin lake, rhodamine lake B, alizarin lake, brilliant carmine 3B, C.I. pigment red 2, C.I. pigment red 3, C.I. pigment red 5, C.I. pigment red 6, C.I. pigment red 7, C.I. pigment red 15, C.I. pigment red 16, C.I. pigment red 48:1, C.I. pigment red 53:1, C.I. pigment red 57:1, C.I. pigment red 122, C.I. pigment red 123, C.I. pigment red 139, C.I. pigment red 144, C.I. pigment red 149, C.I. pigment red 166, C.I. pigment red 177, C.I. pigment red 178, and C.I. pigment red 222.

Purple colorant includes, for example, manganese purple, fast violet B, and methyl violet lake.

Blue colorant includes, for example, Prussian blue, cobalt blue, alkali blue lake, Victoria blue lake, phthalocyanine blue, non-metal phthalocyanine blue, phthalocyanine blue-partial chlorination product, fast sky blue, indanthrene blue BC, C.I. pigment blue 15, C.I. pigment blue 15:2, C.I. pigment blue 15:3, C.I. pigment blue 16, and C.I. pigment blue 60.

Green colorant includes, for example, chromium green, chromium oxide, pigment green B, malachite green lake, final yellow green G, and C.I. pigment green 7.

White colorant includes, for example, those compounds such as zinc white, titanium oxide, antimony white, and zinc sulfide.

The colorants may be used each alone, or two or more of the colorants of different colors may be used in combination. Further, two or more of the colorants with the same color may be used in combination. A usage of the colorant is not limited to a particular amount, and preferably 0.1 part by weight to 20 parts by weight, and more preferably 0.2 part by weight to 10 parts by weight, based on 100 parts by weight of the binder resin.

As the release agent, it is possible to use ingredients which are customarily used in this field, including, for example, petroleum wax such as paraffin wax and derivatives thereof, and microcrystalline wax and derivatives thereof; hydrocarbon-based synthetic wax such as Fischer-Tropsch wax and derivatives thereof, polyolefin wax (e.g. polyethylene wax and polypropylene wax) and derivatives thereof, low-molecular-weight polypropylene wax and derivatives thereof, and polyolefinic polymer wax (low-molecular-weight polyethylene wax, etc.) and derivatives thereof; vegetable wax such as carnauba wax and derivatives thereof, rice wax and derivatives thereof, candelilla wax and derivatives thereof, and haze wax; animal wax such as bees wax and spermaceti wax; fat and oil-based synthetic wax such as fatty acid amides and phenolic fatty acid esters; long-chain carboxylic acids and derivatives thereof; long-chain alcohols and derivatives thereof; silicone polymers; and higher fatty acids. Note that examples of the derivatives include oxides, block copolymers of a vinylic monomer and wax, and graft-modified derivatives of a vinylic monomer and wax. A usage of the wax may be appropriately selected from a wide range without particularly limitation, and preferably 0.2 part by weight to 20 parts by weight, more preferably 0.5 part by weight to 10 parts by weight, and particularly preferably 1.0 part by weight to 8.0 parts by weight, based on 100 parts by weight of the binder resin.

The usable charge control agent includes a positive charge control agent and a negative charge control agent which are customarily used in the relevant field. The positive charge control agent includes, for example, a basic dye, quaternary ammonium salt, quaternary phosphonium salt, aminopyrine, a pyrimidine compound, a polynuclear polyamino compound, aminosilane, a nigrosine dye, a derivative thereof, a triphenylmethane derivative, guanidine salt, and amidine salt. The negative charge control agent includes oil-soluble dyes such as oil black and spiron black, a metal-containing azo compound, an azo complex dye, metal salt naphthenate, salicylic acid, metal complex and metal salt (the metal includes chrome, zinc, and zirconium) of a salicylic acid derivative, a fatty acid soap, long-chain alkylcarboxylic acid salt, and a resin acid soap. One of the above charge control agents may be used each alone and according to need, two or more of the above agents may be used in combination. A usage of the charge control agent is not limited to a particular level and may be selected as appropriate from a wide range. The charge control agent may be contained in the core particles or mixed with the coating layers made of the fine resin particles at the later-described step of coating. In the case where the charge control agent is contained in the core particles, a preferable usage of the charge control agent is 0.5 part by weight to 3 parts by weight based on 100 parts by weight of the binder resin.

The core particles can be manufactured in accordance with a commonly-used method of manufacturing a toner. The commonly-used method of manufacturing a toner includes dry processes such as a pulverization method; and wet processes such as a suspension polymerization method, an emulsification aggregation method, a dispersion polymerization method, a dissolution suspension method, and a melting emulsification method. There will be hereinbelow described a method of fabricating the core particles which employs the pulverization method.

In the pulverization method, a toner composition containing the binder resin, the colorant, and the other toner additive component is dry-mixed by a mixer and thereafter melt-kneaded by a kneader. A kneaded material thus obtained through the melt-kneading process is cooled and solidified into a solidified material which is then pulverized by a pulverizer. A resultant material is subsequently treated with particle size adjustment such as classification according to need. The core particles are thus obtained.

Usable mixers include heretofore known mixers including, for example, Henschel-type mixing apparatuses such as a Henschel mixer (trade name) manufactured by Mitsui Mining Co., a super mixer (trade name) manufactured by Kawata Co., and a MECHANO mill (trade name) manufactured by Okada Seiko Co., Ltd., ONG mill (trade name) manufactured by Hosokawa Micron Co., Hybridization system (trade name) manufactured by Nara Machinery Co., Ltd., and Cosmo system (trade name) manufactured by Kawasaki Heavy Industry Co., Ltd.

Usable kneaders include heretofore known kneaders including, for example, commonly-used kneaders such as a twin-screw extruder, a three roll mill, and laboplast mill. Specific examples of such kneaders include single or twin screw extruders such as TEM-100B (trade name) manufactured by Toshiba Kikai Co., Ltd., PCM-65/87 and PCM-30, both of which are trade names and manufactured by Ikegai Co., and open roll-type kneading machines such as Kneadics (trade name) manufactured by Mitsui Mining Co.

An additive for synthetic resin, such as a colorant, may be formed into a master batch so as to be dispersed evenly into the kneaded material. Moreover, two or more additives for synthetic resin may be formed into a particulate composite. The particulate composite can be manufactured, for example, in a manner that an appropriate amount of water, lower alcohol, or the like material is added to two or more additives for synthetic resin which are then granulated through a commonly-used granulator such as a high-speed mill, followed by being dried. The master batch and the particulate composite are mixed with a powder mixture during a dry-mixing operation.

The average particle size B of the core particles thus obtained is preferably 3 μm to 10 μm, and more preferably 5 μm to 8 μm. With the toner having the core particles whose average particle size B is 3 μm to 10 μm, high-resolution images can be formed stably for a long period of time. In the case where the average particle size B of the core particles is less than 3 μm, the particle size of the core particle is too small, which may cause the toner to be excessively charged and have a low fluidity. The excessively-charged toner having the low fluidity cannot be stably supplied to the photoreceptor, thus causing background fog and a decrease in image density. In the case where the average particle size B of the core particles exceeds 10 μm, the particle size of the core particle is so large that high-resolution images cannot be obtained. Further, the larger particle size of the core particle leads to a decrease in a specific surface area thereof, resulting in a smaller charge amount of the toner. The toner less charged cannot be stably supplied to the photoreceptor and may spatter inside the apparatus to cause internal contamination.

(Step of Preparing Fine Resin Particles and Adhering Aid)

At Step s2 of preparing fine resin particles and an adhering aid, fine resin particles containing at least resin are fabricated, and an adhering aid for increasing adherence between the core particles and the fine resin particles is prepared.

Resin usable for the fine resin particles is not particularly limited and thus includes, for example, polyester, acrylic resin, styrene-acryl copolymer resin, and styrene resin. It is preferred that the fine resin particles contain acryl resin, styrene-acryl copolymer resin, or polyester, among those resin cited above. The acryl resin, styrene-acryl copolymer resin, or polyester has many advantages such as being lightweight, strong, high in transparency, and inexpensive.

The resin contained in the fine resin particles may be of the same sort as that of the binder resin contained in the core particles. Resin different from the binder resin contained in the core particles is also applicable for the fine resin particles, and from the perspective of treating the toner with surface modification, the use of different resin is preferred. In the case of using such different resin for the fine resin particles, it is preferable to select resin whose softening temperature is higher than that of the binder resin contained in the core particles. By so doing, the toner is prevented from being fused to each other while stored, allowing for enhancement in storage stability. The softening temperature of the resin contained in the fine resin particles is preferably 80° C. to 140° C. although it depends on an image forming apparatus where the toner is used. The use of the resin having a temperature in the above range will result in a toner which exhibits good storage stability and fixing performance.

The fine resin particles as described above can be obtained by polymerizing monomers, for example. Further, the fine resin particles can also be obtained in a manner that raw materials of the fine resin particles are emulsified and dispersed into fine grains by using a homogenizer or the like machine.

The volume average particle size of fine resin particles before fusion needs to be smaller enough than the average particle size B of the core particles. Furthermore, the volume average particle size of fine resin particles before fusion is preferably 0.05 μm or more and less than 1 μm, and more preferably 0.05 μm to 0.5 μm. When the volume average particle size of fine resin particles before fusion is 0.05 μm to 0.5 μm, favorably-sized protrusions are formed on the surfaces of the coating layers. Owing to the protrusions, the toner is easily caught by a cleaning blade, thereby enhancing the cleaning property. Further, in this case, even an increase of the low-softening component contained in the toner does not cause the low-softening component to be exposed on the surface of the toner, leading to an increase in surface hardness without impairing the fixing property and thus allowing for enhancement in storage stability and mechanical strength.

When the volume average particle size of fine resin particles before fusion is less than 0.05 μm, the protrusions thus formed are so low in height that the cleaning property may be deteriorated. Moreover, in this case, the fine resin particles are of such small size as to be harder to deal with. Besides, in the case where the fine resin particles and the adhering aid are mixed and atomized in form of fine resin particle dispersion by one atomizing nozzle at the later-described step of coating, the fine resin particles may be less dispersive into the fine resin particle dispersion.

When the volume average particle size of fine resin particles before fusion is 1 μm or more, the protrusions thus formed are high, which increase a proportion of the coating layer in the toner. In this case, it is difficult for the coating layer to be fused evenly to the surface of the toner. When the proportion of the coating layer in the toner is large, the coating layer is so influential in forming images that desired images may not be formed, through it depends on a material forming the coating layer.

At Step s2 of preparing the fine resin particles and the adhering aid, the adhering aid for increasing the adherence between the core particles and the fine resin particles is prepared. The adhering aid indicates liquid which can enhance the wettability of the fine resin particles to the core particles. The adhering aid is preferably liquid in which the core particles are not dissolved. Since the adhering aid needs to be removed after coating of the fine resin particles, volatile liquid is preferred.

The adhering aid preferably include, for example, water or lower alcohol. Examples of the lower alcohol are methanol, ethanol, and propanol.

The adhering aid is not limited to those materials cited above and thus includes, for example, alcohols such as butanol, diethylene glycol, and grycerin; ketones such as acetone and methyl ethyl ketone; and esters such as methyl acetate and ethyl acetate.

(Step of Coating)

At Step s3 of coating, the fine resin particles are attached and fused to the core particles with use of the adhering aid for increasing the adherence between the core particles and the fine resin particles. By so doing, the core particles are coated with the fine resin particles. The coating layer is thus formed.

At the step of coating, a surface-modifying apparatus is used, for example. In the embodiment, the surface-modifying apparatus includes: a container for housing the core particles and the fine resin particles; an atomizer for atomizing the adhering aid into the container; and an agitator for agitating the core particles inside the container.

A container of closed type may be used as the container for housing the core particles and the fine resin particles. The atomizer has an adhering aid reservoir for housing the adhering aid; a carrier gas reservoir for housing carrier gas; and a liquid-atomizing unit for atomizing the adhering aid into droplets which are given to the core particles contained inside the container by spraying a mixture of the adhering aid and the carrier gas to the core particles. The carrier gas may be compressed air or the like gas. The liquid-atomizing apparatus is available in the market, including such an apparatus that a binary fluid nozzle: HM-6 (trade name) manufactured by Fuso Seiki Co., Ltd. is connected to a tube pump: MP-1000A (trade name) manufactured by Tokyo Rikakikai Co., Ltd. through which a metered quantity of the adhering aid can be supplied. The agitator may be an agitator rotor which can provide the core particles with mechanical and thermal energy based on impact force.

The container provided with the agitator is available in the market, including Henschel-type mixing apparatuses such as a Henschel mixer (trade name) manufactured by Mitsui Mining Co., a super mixer (trade name) manufactured by Kawata Co., and a MECHANO mill (trade name) manufactured by Okada Seiko Co., Ltd., ONG mill (trade name) manufactured by Hosokawa Micron Co., Hybridization system (trade name) manufactured by Nara Machinery Co., Ltd., and Cosmo system (trade name) manufactured by Kawasaki Heavy Industry Co., Ltd. The liquid-atomizing unit is installed in a container having the above-cited mixer, which can be then used as the surface-modifying apparatus according to the present embodiment.

The coating of the fine resin particles is performed on the core particles as follows. At the outset, the core particles and the fine resin particles are put in the container and agitated therein by the agitator while the adhering aid is atomized into the container. To the core particles and the fine resin particles, the atomized adhering aid is given and the thermal energy is added by agitation so that the surfaces of the core particles and the fine resin particles are swollen and softened. In addition, the mechanical impact force generated by the agitator is also applied to the core particles and the fine resin particles so that the fine resin particles are firmly adhered to the surfaces of the core particles and simultaneously, the fine resin particles are partially fused to at least either the core particles or the adjacent fine resin particles. This enables the fine resin particles to be attached and thus fused to the entire surfaces of the core particles.

A temperature inside the container of the surface-modifying apparatus is preferably less than a glass transition temperature of the binder resin contained in the core particles. When the temperature inside the container is equal to or higher than the glass transition temperature of the binder resin contained in the core particles, the core particles may be excessively fused to aggregate inside the container in manufacturing the toner. It is therefore preferable to cool down the inside of the surface-modifying apparatus so as to prevent the core particles from aggregating.

Furthermore, it is preferred that the adhering aid be atomized in the state where the core particles are suspended inside the container. In the case where the mixture of the fine resin particles and the adhering aid is atomized in the state where the core particles are suspended inside the container, the core particles coated with the atomized adhering aid are in contact with each other in a shorter length of time. This enables to prevent the toner aggregation so as not to generate coarse particles in manufacturing the toner, thus allowing for a toner made of particles uniform in size. The core particles can be suspended inside the container, for example, by agitation of the agitator or the air supply.

A use ratio of the fine resin particles is not limited to a particular level, but needs to be such a ratio as to coat the entire surfaces of the core particles. The fine resin particles are used preferably at a ratio of 1 part by weight to 30 parts by weight based on 100 parts by weight of the core particles. The use of the fine resin particles less than 1 part by weight may cause a failure to coat the entire surfaces of the fine resin particles with the coating layers. The use of the fine resin particles exceeding 30 parts by weight may cause the coating layer to be too large in thickness, possibly leading to deterioration of the fixing property of the toner, depending on a material constituting the fine resin particles.

A usage of the adhering aid is not limited to a particular amount, and preferable is such an amount as to have the entire surfaces of the core particles wet. The usage of the adhering aid is determined based on the usage of the core particles. Further, the amount of the adhering aid can be adjusted by changing a length of time, a frequency, etc. of the atomization effected by the atomizer. For such an adjustment, it is only necessary to terminate the atomization of adhering aid effected by the atomizer, for example, at the moment when most of the fine resin particles present in the container are attached to the core particles, after setting the average particle size of the core particles, the use ratio of the core particles and the fine resin particles, and a per-hour atomization amount of the atomizer depending on a material of the core particles, a material of the fine resin particles, and the like element.

The core particles may be coated with the fine resin particles by a surface-modifying apparatus which includes: a container for housing the core particles; an atomizer for atomizing the mixture of the fine resin particles and the adhering aid into the container; and an agitator for agitating the core particles inside the container. The surface-modifying apparatus as just stated may be the same as the apparatus mentioned above except the mixture of the adhering aid and the fine resin particles is not stored in the adhering aid reservoir.

The above surface-modifying apparatus performs the coating of the fine resin particles on the core particles as follows. At the outset, the core particles are put in the container and agitated therein by the agitator while the mixture of the adhering aid and the fine resin particles is atomized into the container. To the core particles, the atomized adhering aid is given and the thermal energy is added by agitation so that the surfaces of the core particles are swollen and softened. The fine resin particles which are mixed with the adhering aid are also atomized into the container and then given the thermal energy through agitation so that the surfaces of the fine resin particles are swollen and softened as well as the core particles. In addition, the mechanical impact force generated by the agitator is also applied to the core particles and the fine resin particles so that the fine resin particles are firmly adhered to the surfaces of the core particles and simultaneously, the fine resin particles are partially fused to at least either the core particles or the adjacent fine resin particles. This enables the fine resin particles to be attached and thus fused to the entire surfaces of the core particles.

In the case of atomizing the mixture of the adhering aid and the fine resin particles, a preferable usage of the adhering aid is 1 part by weight to 99 parts by weight based on 1 part by weight of the fine resin particles. The mixture of the adhering aid and the fine resin particles, namely, a coating solution, has been prepared in advance at Step s2 of preparing the fine resin particles and the adhering aid. In the case of atomizing the fine resin particles and the adhering aid by one atomizer, the use of the mixture containing the fine resin particles and the adhering aid in the above ratio can sufficiently enhance the wettability of the fine resin particles to the core particles and moreover shorten the length of time necessary to remove the adhering aid. Further, in this case, the mixture has such favorable viscosity as to be easily atomized by the atomizer. The mixture containing the adhering aid less than 1 part by weight is too viscous, with which nozzle holes of the atomizing unit may be clogged. When the usage of the adhering aid exceeds 99 parts by weight, a content of the adhering aid is too large, requiring an excessively long time for removing the adhering aid.

A usage of the mixture of the fine resin particles and the adhering aid is not limited to a particular amount, but needs to be such that an amount of the contained fine resin particles is large enough to coat the entire surfaces of the core particles. Since a preferable amount of the fine resin particles for coating the entire surfaces of the core particles is 1 part by weight to 30 parts by weight based on 100 parts by weight of the core particles as in the above case, the usage of the mixture is determined in accordance with the content of the fine resin particles in the mixture.

After the entire surfaces of the core particles have been coated with the fine resin particles, the adhering aid is removed. The removal of the adhering aid is carried out by using a drier or the like machine to gasify the adhering aid. The drier for use in removal of the adhering aid may be a commonly-used drier such as a hot-air heat-receiving drier, a conductive drier, or a freeze drier.

As described above, the toner of the invention is obtained that includes the coating layers which are formed on the entire surfaces of the core particles and where the fine resin particles are partially fused to at least either the core particles or the adjacent fine resin particles. In the above-described toner, the fine resin particles fused to the core particles increase the adherence between the coating layers and the core particles so that the coating layers can be prevented from being desorbed from the core particles upon agitating the developer in the developer container, for example. As a result, the toner can be prevented from changing in property in the course of long-term use. Since the fine resin particles are only partially fused, tiny protrusions are formed on the surface of the coating layer by some parts of the fine resin particles covering the core particles which remain not fused. Such parts form a tiny protrusion on the surface of the coating layer. Owing to the tiny protrusion, the toner is easily caught by a cleaning blade, thereby enhancing the cleaning property. The protrusion further contributes to an increase in the surface area of the toner, which provides more favorable property of frictional electrification than that of a toner having no coating layers formed on core particles. The toner with the favorable property of frictional electrification exhibits improved performance in the transfer process and the development process, thus enabling to form high-quality images.

To the toner of the invention, an external additive may be added. As the external additive, heretofore known ingredients can be used, including silica and titanium oxide. It is preferred that these ingredients be surface-treated with silicone resin and a silane coupling agent. A preferable usage of the external additive is 1 part by weight to 10 parts by weight based on 100 parts by weight of the toner.

The toner of the invention can be used in form of either one-component developer or two-component developer. In the case where the toner is used in form of one-component developer, only the toner is used without carriers while a blade and a fur brush are used to effect the fictional electrification at a developing sleeve so that the toner is attached onto the sleeve, thereby conveying the toner to perform image formation. Further, in the case where the toner is used in form of two-component developer, the toner of the invention is used together with a carrier. As the carrier, heretofore known ingredients can be used including, for example, single or complex ferrite composed of iron, copper, zinc, nickel, cobalt, manganese, and chromium; a resin-coated carrier having carrier core particles whose surfaces are coated with coating substances; or a resin-dispersion carrier in which magnetic particles are dispersed in a resin. As the coating substance, heretofore known ingredients can be used including polytetrafluoroethylene, a monochloro-trifluoroethylene polymer, polyvinylidene-fluoride, silicone resin, polyester resin, a metal compound of di-tertiary-butylsalicylic acid, styrene resin, acrylic resin, polyamide, polyvinyl butyral, nigrosine, aminoacrylate resin, basic dyes or lakes thereof, fine silica powder, and fine alumina powder. In addition, the resin used for the resin-dispersion carrier is not limited to particular resin, and examples thereof include styrene-acryl resin, polyester resin, fluorine resin, and phenol resin. Both of the coating substance in the resin-coated carrier and the resin used for the resin-dispersion carrier are preferably selected according to the toner components. Those substances and resin listed above may be used each alone, and two or more thereof may be used in combination.

A shape of the carrier is preferably a spherical shape or flattened shape. A particle size of the carrier is not limited to a particular diameter, and in consideration of forming higher-quality images, the particle size of the carrier is preferably 10 μm to 100 μm, and more preferably 20 μm to 50 μm. Further, the resistivity of the carrier is preferably 10⁸ Ω·cm or more, and more preferably 10¹² Ω·cm or more. The resistivity of the carrier is obtained as follows. At the outset, the carrier is put in a container having a cross section of 0.50 cm², thereafter being tapped. Subsequently, a load of 1 kg/cm² is applied by use of a weight to the carrier particles which are held in the container as just stated. When an electric field of 1,000 V/cm is generated between the weight and a bottom electrode of the container by application of voltage, a current value is read. The current value is the resistivity of the carrier. When the resistivity of the carrier is low, electric charges will be injected into the carrier upon application of bias voltage to a developing sleeve, thus causing the carrier particles to be more easily attached to the photoreceptor. In this case, the breakdown of bias voltage is more liable to occur.

Magnetization intensity (maximum magnetization) of the carrier is preferably 10 emu/g to 60 emu/g, and more preferably 15 emu/g to 40 emu/g. The magnetization intensity depends on magnetic flux density of a developing roller. Under the condition of ordinary magnetic flux density of the developing roller, however, no magnetic binding force work on the carrier having the magnetization intensity less than 10 emu/g, which may cause the carrier to spatter. The carrier having the magnetization intensity larger than 60 emu/g has bushes which are too large to keep the non-contact state with the image bearing member in the non-contact development or to possibly cause sweeping streaks to appear on a toner image in the contact development.

A use ratio of the toner to the carrier in the two-component developer is not limited to a particular ratio, and the use ratio is appropriately selected according to kinds of the toner and carrier. To take the resin-coated carrier (having density of 5 g/cm² to 8 g/cm²) as an example, the usage of the toner may be determined such that a content of the toner in the developer is 2% by weight to 30% by weight and preferably 2% by weight to 20% by weight of the total amount of the developer. Further, in the two-component developer, a coverage of the carrier with the toner is preferably 40% to 80%.

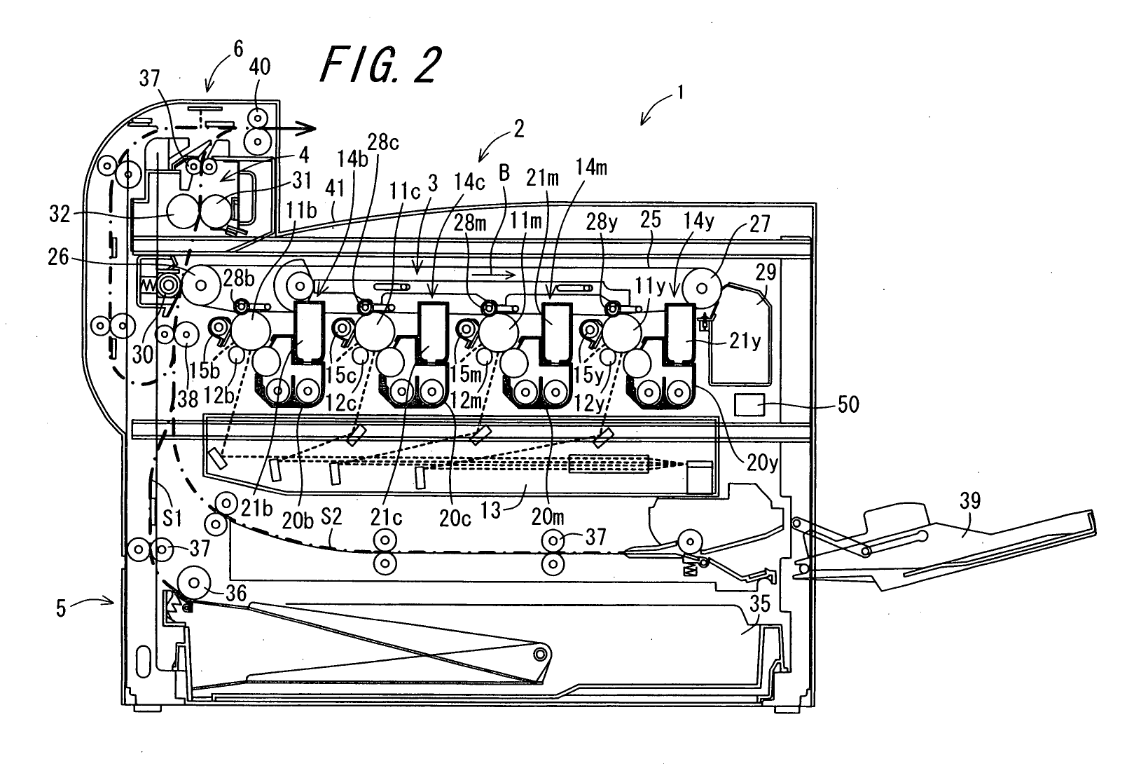

FIG. 2 is a cross-sectional view schematically showing a configuration of an image forming apparatus 1 according to the invention. The image forming apparatus 1 is a multifunctional system which combines a copier function, a printer function, and a facsimile function. In the image forming apparatus 1, according to image information transmitted thereto, a full-color or black-and-white image is formed on a recording medium. To be specific, three print modes, i.e., a copier mode (duplicate mode), a printer mode, and a facsimile mode are available in the image forming apparatus 1, one of which print modes is selected by a control section (not shown) in response to an operation input given by an operating section (not shown) or a print job given by a personal computer, a mobile computer, an information record storage medium, or an external equipment having a memory unit. The image forming apparatus 1 includes a toner image forming section 2, a transferring section 3, a fixing section 4, a recording medium supplying section 5, and a discharging section 6. In accordance with image information of respective colors of black (b), cyan (c), magenta (m), and yellow (y) which are contained in color image information, there are provided respectively four sets of the components constituting the toner image forming section 2 and some parts of the components contained in the transfer section 3. The four sets of respective components provided for the respective colors are distinguished herein by giving alphabets indicating the respective colors to the end of the reference numerals, and in the case where the sets are collectively referred to, only the reference numerals are shown.

The toner image forming section 2 includes a photoreceptor drum 11, a charging section 12, an exposure unit 13, a developing section 14, and a cleaning unit 15. The charging section 12, the developing section 14, and the cleaning unit 15 are disposed in the order just stated around the photoreceptor drum 11 toward a downstream side along a direction in which the photoreceptor drum 11 rotates. The charging section 12 is disposed below the developing section 14 and the cleaning unit 15 when viewed in a vertical direction.

The photoreceptor drum 11 is rotatably supported about an axis thereof by a driving mechanism (not shown), and includes a conductive substrate and a photosensitive layer formed on a surface of the conductive substrate (not shown). The conductive substrate may be formed into various shapes such as a cylindrical shape, a circular columnar shape, and a thin film sheet shape. Among these shapes, the cylindrical shape is preferred. The conductive substrate is formed of a conductive material. As the conductive material, those customarily used in the relevant field can be used including, for example, metals such as aluminum, copper, brass, zinc, nickel, stainless steel, chromium, molybdenum, vanadium, indium, titanium, gold, and platinum; alloys formed of two or more of the metals; a conductive film in which a conductive layer containing one or two or more of aluminum, aluminum alloy, tin oxide, gold, indium oxide, etc. is formed on a film-like substrate such as of synthetic resin film, metal film, and paper; and a resin composition containing conductive particles and/or conductive polymers. As the film-like substrate used for the conductive film, a synthetic resin film is preferred and a polyester film is particularly preferred. Further, as the method of forming the conductive layer in the conductive film, vapor deposition, coating, etc. are preferred.

The photosensitive layer is formed, for example, by stacking a charge generating layer containing a charge generating substance, and a charge transporting layer containing a charge transporting substance. In this case, an undercoat layer is preferably formed between the conductive substrate and the charge generating layer or the charge transporting layer. Provision of the undercoat layer offers advantages such as covering the flaws and irregularities present on the surface of the conductive substrate to thereby smooth the surface of the photosensitive layer, preventing degradation of the chargeability of the photosensitive layer during repetitive use, and enhancing the charging property of the photosensitive layer under a low temperature and/or low humidity circumstance. Further, the photosensitive layer may be a layered type photoreceptor having a highly-durable three-layer structure in which a photoreceptor surface-protecting layer is provided on the top layer.

The charge generating layer contains as a main ingredient a charge generating substance that generates charges under irradiation of light, and optionally contains known binder resin, plasticizer, sensitizer, etc. As the charge generating substance, materials used customarily in the relevant field can be used including, for example, perylene pigments such as perylene imide and perylenic acid anhydride; polycyclic quinone pigments such as quinacridone and anthraquinone; phthalocyanine pigments such as metal and non-metal phthalocyanines, and halogenated non-metal phthalocyanines; squalium dyes; azulenium dyes; thiapylirium dyes; and azo pigments having carbazole skeleton, styrylstilbene skeleton, triphenylamine skeleton, dibenzothiophene skeleton, oxadiazole skeleton, fluorenone skeleton, bisstilbene skeleton, distyryloxadiazole skeleton, or distyryl carbazole skeleton. Among those charge generating substances, non-metal phthalocyanine pigments, oxotitanyl phthalocyanine pigments, bisazo pigments containing fluorene rings and/or fluorenone rings, bisazo pigments containing aromatic amines, and trisazo pigments have high charge generating ability and are suitable for obtaining a photosensitive layer at high sensitivity. The charge generating substances may be used each alone, or two or more of the charge generating substances may be used in combination. The content of the charge generating substance is not particularly limited, and preferably from 5 parts by weight to 500 parts by weight, and more preferably from 10 parts by weight to 200 parts by weight, based on 100 parts by weight of a binder resin in the charge generating layer. Also as the binder resin for charge generating layer, materials used customarily in the relevant field can be used including, for example, melamine resin, epoxy resin, silicone resin, polyurethane, acryl resin, vinyl chloride-vinyl acetate copolymer resin, polycarbonate, phenoxy resin, polyvinyl butyral, polyallylate, polyamide, and polyester. The binder resins may be used each alone or, optionally, two or more of the resin may be used in combination.

The charge generating layer can be formed by dissolving or dispersing an appropriate amount of a charge generating substance, a binder resin and, optionally, a plasticizer, a sensitizer, etc. respectively in an appropriate organic solvent which is capable of dissolving or dispersing the ingredients described above, to thereby prepare a coating solution for charge generating layer, and then applying the coating solution for charge generating layer to the surface of the conductive substrate, followed by drying. The thickness of the charge generating layer obtained in this way is not particularly limited, and preferably from 0.05 μm to 5 μm, and more preferably from 0.1 μm to 2.5 μm.

The charge transporting layer stacked over the charge generating layer contains as an essential ingredient a charge transporting substance having an ability of receiving and transporting charges generated from the charge generating substance, and a binder resin for charge transporting layer, and optionally contains known antioxidant, plasticizer, sensitizer, lubricant, etc. As the charge transporting substance, materials used customarily in the relevant field can be used including, for example: electron donating materials such as poly-N-vinyl carbazole, a derivative thereof, poly-γ-carbazolyl ethyl glutamate, a derivative thereof, a pyrene-formaldehyde condensation product, a derivative thereof, polyvinylpyrene, polyvinyl phenanthrene, an oxazole derivative, an oxadiazole derivative, an imidazole derivative, 9-(p-diethylaminostyryl)anthracene, 1,1-bis(4-dibenzylaminophenyl)propane, styrylanthracene, styrylpyrazoline, a pyrazoline derivative, phenyl hydrazones, a hydrazone derivative, a triphenylamine compound, a tetraphenyldiamine compound, a triphenylmethane compound, a stilbene compound, and an azine compound having 3-methyl-2-benzothiazoline ring; and electron accepting materials such as a fluorenone derivative, a dibenzothiophene derivative, an indenothiophene derivative, a phenanthrenequinone derivative, an indenopyridine derivative, a thioquisantone derivative, a benzo[c]cinnoline derivative, a phenazine oxide derivative, tetracyanoethylene, tetracyanoquinodimethane, bromanil, chloranil, and benzoquinone. The charge transporting substances may be used each alone, or two or more of the charge transporting substances may be used in combination. The content of the charge transporting substance is not particularly limited, and preferably from 10 parts by weight to 300 parts by weight, and more preferably from 30 parts by weight to 150 parts by weight, based on 100 parts by weight of the binder resin in the charge transporting substance. As the binder resin for charge transporting layer, it is possible to use materials which are used customarily in the relevant field and capable of uniformly dispersing the charge transporting substance, including, for example, polycarbonate, polyallylate, polyvinylbutyral, polyamide, polyester, polyketone, epoxy resin, polyurethane, polyvinylketone, polystyrene, polyacrylamide, phenolic resin, phenoxy resin, polysulfone resin, and copolymer resin thereof. Among those materials, in view of the film forming property, and the wear resistance, electrical characteristics etc. of the obtained charge transporting layer, it is preferable to use, for example, polycarbonate which contains bisphenol Z as the monomer ingredient (hereinafter referred to as “bisphenol Z polycarbonate”), and a mixture of bisphenol Z polycarbonate and other polycarbonate. The binder resin may be used each alone, or two or more of the binder resin may be used in combination.

The charge transporting layer preferably contains an antioxidant together with the charge transporting substance and the binder resin for charge transporting layer. Also for the antioxidant, materials used customarily in the relevant field can be used including, for example, Vitamin E, hydroquinone, hindered amine, hindered phenol, paraphenylene diamine, arylalkane and derivatives thereof, an organic sulfur compound, and an organic phosphorus compound. The antioxidants may be used each alone, or two or more of the antioxidants may be used in combination. The content of the antioxidant is not particularly limited, and is 0.01% by weight to 10% by weight and preferably 0.05% by weight to 5% by weight of the total amount of the ingredients constituting the charge transporting layer. The charge transporting layer can be formed by dissolving or dispersing an appropriate amount of a charge transporting substance, a binder resin and, optionally, an antioxidant, a plasticizer, a sensitizer, etc. respectively in an appropriate organic solvent which is capable of dissolving or dispersing the ingredients described above, to thereby prepare a coating solution for charge transporting layer, and applying the coating solution for charge transporting layer to the surface of a charge generating layer followed by drying. The thickness of the charge transporting layer obtained in this way is not particularly limited, and preferably 10 μm to 50 μm, and more preferably 15 μm to 40 μm. Note that it is also possible to form a photosensitive layer in which a charge generating substance and a charge transporting substance are present in one layer. In this case, the kind and content of the charge generating substance and the charge transporting substance, the kind of the binder resin, and other additives may be the same as those in the case of forming separately the charge generating layer and the charge transporting layer.

In the embodiment, as described above, there is used a photoreceptor drum which has an organic photosensitive layer containing the charge generating substance and the charge transporting substance. It is, however, also possible to use, instead of the above photoreceptor drum, a photoreceptor drum which has an inorganic photosensitive layer containing silicon or the like.

The charging section 12 faces the photoreceptor drum 11 and is disposed away from the surface of the photoreceptor drum 11 over an entire length thereof when viewed in a longitudinal direction. The charging section 12 charges the surface of the photoreceptor drum 11 so that the surface of the photoreceptor drum 11 has predetermined polarity and potential. As the charging section 12, it is possible to use a charging brush type charger, a charger type charger, a saw tooth type charger, an ion-generating apparatus, etc. Although the charging section 12 is disposed away from the surface of the photoreceptor drum 11 in the embodiment, the configuration is not limited thereto. For example, a charging roller may be used as the charging section 12, and the charging roller may be disposed in contact-pressure with the photoreceptor drum 11. It is also possible to use a contact-charging type charger such as a charging brush or a magnetic brush.

The exposure unit 13 is disposed so that light corresponding to respective color information emitted from the exposure unit 13 passes between the charging section 12 and the developing section 14 to reach the surface of the photoreceptor drum 11. In the exposure unit 13, the image information is examined to thereby form branched light corresponding to respective color information of black (b), cyan (c), magenta (m), and yellow (y) in each unit, and the surface of the photoreceptor drum 11 which has been evenly charged by the charging section 12, is exposed to the light corresponding to the respective color information to thereby form an electrostatic latent image on the surface of the photoreceptor drum 11. As the exposure unit 13, it is possible to use a laser scanning unit having a laser-emitting portion and a plurality of reflecting mirrors. The other usable examples of the exposure unit 13 may include an LED array and a unit in which a liquid-crystal shutter and a light source are appropriately combined with each other.

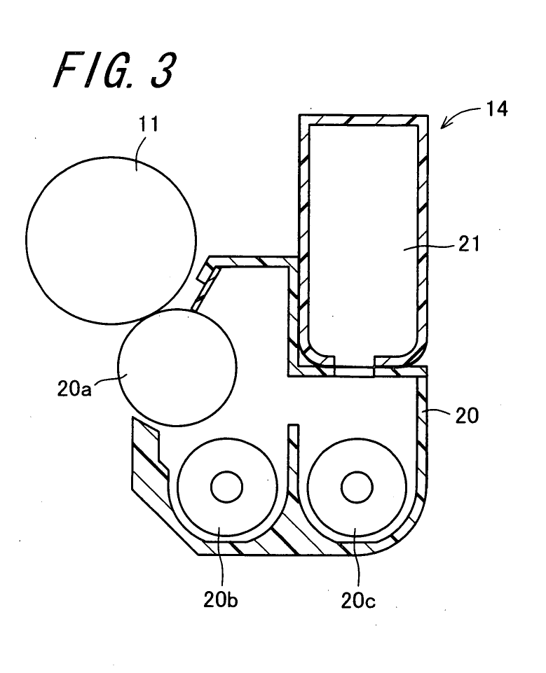

FIG. 3 is a cross-sectional view schematically showing a configuration of the developing section 14 according to the invention. The developing section 14 includes a developer tank 20 and a toner hopper 21. The developer tank 20 is a container-shaped member which is disposed so as to face the surface of the photoreceptor drum 11 and used to supply a toner to an electrostatic latent image formed on the surface of the photoreceptor drum 11 so as to develop the electrostatic latent image into a visualized image, i.e. a toner image. The developer tank 20 contains in an internal space thereof the developer, and rotatably supports roller members such as a developing roller 20a, a supplying roller 20b, and an agitating roller 20c or screw members, which members are contained in the developer tank 20. The developer tank 20 has an opening in a side face thereof opposed to the photoreceptor drum 11. The developing roller 20a is rotatably provided at a position where the developing tank 20a faces the photoreceptor drum 11 through the opening just stated. The developing roller 20a is a roller-shaped member for supplying a toner to the electrostatic latent image on the surface of the photoreceptor 11 at a pressure-contact portion or most-adjacent portion between the developing roller 20a and the photoreceptor drum 11. In supplying the toner, to a surface of the developing roller 20a is applied a potential whose polarity is opposite to a polarity of the potential of the charged toner, which serves as a development bias voltage (hereinafter referred to simply as “development bias”). By so doing, the toner on the surface of the developing roller 20a is smoothly supplied to the electrostatic latent image. Furthermore, an amount of the toner being supplied to the electrostatic latent image (a toner-attached amount) can be controlled by changing a value of the development bias. The supply roller 20b is a roller-shaped member which is rotatably disposed opposite to the developing roller 20a and used to supply the toner to the vicinity of the developing roller 20a. The agitating roller 20c is a roller-shaped member which is rotatably disposed opposite to the supplying roller 20b and used to feed to the vicinity of the supplying roller 20b the toner which is newly supplied from the toner hopper 21 into the developer tank 20. The toner hopper 21 is disposed so as to communicate a toner replenishment port (not shown) formed in a lower part in a vertical direction thereof, with a toner reception port (not shown) formed in an upper part in a vertical direction of the developer tank 20. The toner hopper 21 replenishes the developer tank 20 with the toner according to toner consumption. Further, it may be possible to adopt such a configuration that the developer tank 20 is replenished with the toner supplied directly from a toner cartridge of each color without using the toner hopper 21.

In reference to FIG. 2, the cleaning unit 15 removes the toner which remains on the surface of the photoreceptor drum 11 after the toner image has been transferred to the recording medium, and cleans the surface of the photoreceptor drum 11. In the cleaning unit 15 is used a platy member such as a cleaning blade. In the image forming apparatus 1 of the invention, an organic photoreceptor drum is mainly used as the photoreceptor drum 11. A surface of the organic photoreceptor drum contains a resin component as a main ingredient and therefore deteriorates by chemical action of ozone which is generated by corona discharging of the charging apparatus. The degraded surface part is, however, worn away by abrasion through the cleaning unit 15 and thus removed reliably, though gradually. Accordingly, the problem of the surface degradation caused by the ozone, etc. is actually solved, and it is thus possible to stably maintain the potential of charges given by the charging operation over a long period of time. Although the cleaning unit 15 is provided in the embodiment, no limitation is imposed on the configuration, and there may be no cleaning unit 15.

In the toner image forming section 2, signal light corresponding to the image information is emitted from the exposure unit 13 to the surface of the photoreceptor drum 11 which has been evenly charged by the charging section 12, thereby forming an electrostatic latent image; the toner is then supplied from the developing section 14 to the electrostatic latent image, thereby forming a toner image; the toner image is transferred to an intermediate transfer belt 25; and the toner which remains on the surface of the photoreceptor drum 11 is removed by the cleaning unit 15. A series of toner image forming operations just described are repeatedly carried out.

The transfer section 3 is disposed above in a vertical direction of the photoreceptor drum 11, and includes the intermediate transfer belt 25, a driving roller 26, a driven roller 27, an intermediate transferring roller 28 (b, c, m, y), a transfer belt cleaning unit 29, and a transfer roller 30. The intermediate transfer belt 25 is an endless belt stretched out by the driving roller 26 and the driven roller 27, thereby forming a loop-shaped travel path. The intermediate transfer belt 25 rotates in an arrow B direction. When the intermediate transfer belt 25 passes by the photoreceptor drum 11 in contact therewith, the transfer bias whose polarity is opposite to the polarity of the charged toner on the surface of the photoreceptor drum 11 is applied from the intermediate transferring roller 28 which is disposed opposite to the photoreceptor drum 11 via the intermediate transfer belt 25, with the result that the toner image formed on the surface of the photoreceptor drum 11 is transferred onto the intermediate transfer belt 25. In the case of a multicolor image, the toner images of respective colors formed by the respective photoreceptor drums 11 are sequentially transferred onto the intermediate transfer belt 21 and combined thereon, thus forming a multicolor image.

The driving roller 26 can rotate about an axis thereof with the aid of a driving mechanism (not shown), and the rotation of the driving roller 26 drives the intermediate transfer belt 25 to rotate in the arrow B direction. The driven roller 27 can be driven to rotate by the rotation of the driving roller 26, and imparts constant tension to the intermediate transfer belt 25 so that the intermediate transfer belt 25 does not go slack. The intermediate transfer roller 28 is disposed in pressure-contact with the photoreceptor drum 11 via the intermediate transfer belt 25, and capable of rotating about its own axis by a driving mechanism (not shown). The intermediate transfer belt 28 is connected to a power source (not shown) for applying the transfer bias as described above, and has a function of transferring the toner image formed on the surface of the photoreceptor drum 11 to the intermediate transfer belt 25.

The transfer belt cleaning unit 29 is disposed opposite to the driven roller 27 via the intermediate transfer belt 25 so as to come into contact with an outer circumferential surface of the intermediate transfer belt 25. The toner which is attached to the intermediate transfer belt 25 by contact with the photoreceptor drum 11 may cause contamination on a reverse side of a recording medium. The transfer belt cleaning unit 29 thus removes and collects the toner on the surface of the intermediate transfer belt 25. The transfer roller 30 is disposed in pressure-contact with the driving roller 26 via the intermediate transfer belt 25, and capable of rotating about its own axis by a driving mechanism (not shown).

At a pressure-contact portion (a transfer nip area) between the transfer roller 30 and the driving roller 26, a toner image which has been carried by the intermediate transfer belt 25 and thereby conveyed to the pressure-contact portion is transferred onto a recording medium fed from the later-described recording medium supplying section 5. The recording medium carrying the toner image is fed to the fixing section 4. In the transfer section 3, the toner image is transferred from the photoreceptor drum 11 onto the intermediate transfer belt 25 at the pressure-contact portion between the photoreceptor drum 11 and the intermediate transfer roller 28, and by the intermediate transfer belt 25 rotating in the arrow B direction, the transferred toner image is conveyed to the transfer nip area where the toner image is transferred onto the recording medium.

The fixing section 4 is provided downstream of the transfer section 3 along a conveyance direction of the recording medium, and contains a fixing roller 31 and a pressurizing roller 32. The fixing roller 31 can rotate by a driving mechanism (not shown), and heats the toner constituting an unfixed toner image carried on the recording medium so that the toner is fused to be fixed on the recording medium. Inside the fixing roller 31 is provided a heating portion (not shown). The heating portion heats the heating roller 31 so that a surface of the heating roller 31 has a predetermined temperature (heating temperature). For the heating portion, a heater, a halogen lamp, and the like apparatus can be used. The heating portion is controlled by the later-described fixing condition control unit. Detailed descriptions will be hereinafter given regarding the control of the heating temperature conducted by the fixing condition control unit.

In the vicinity of the surface of the fixing roller 31 is provided a temperature detecting sensor which detects a surface temperature of the fixing roller 31. A result detected by the temperature detecting sensor is written to a storage portion of the later-described control unit 50. The pressurizing roller 32 is disposed in pressure-contact with the fixing roller 31, and supported so as to be rotatably driven by the rotation of the pressurizing roller 32. The pressurizing roller 32 helps the toner image to be fixed onto the recording medium by pressing the toner and the recording medium when the toner is fused to be fixed on the recording medium by the fixing roller 31. A pressure-contact portion between the fixing roller 31 and the pressurizing roller 32 is a fixing nip area. In the fixing section 4, the recording medium onto which the toner image has been transferred in the transfer section 3 is nipped by the fixing roller 31 and the pressurizing roller 32 so that when the recording medium passes through the fixing nip area, the toner mage is pressed and thereby fixed on the recording medium under heat, whereby an image is formed.

The recording medium supplying section 5 includes an automatic paper feed tray 35, a pickup roller 36, a conveying roller 37, a registration roller 38, and a manual paper feed tray 39. The automatic paper feed tray 35 is disposed in a lower part in a vertical direction of the image forming apparatus 1 and in form of a container-shaped member for storing the recording mediums. Examples of the recording medium include, for example, plain paper, color copy paper, sheets for over head projector, and post cards. The pickup roller 36 takes out sheet by sheet the recording mediums stored in the automatic paper feed tray 35, and feeds the recording mediums to a paper conveyance path S1.

The conveying roller 37 is a pair of roller members disposed in pressure-contact with each other, and conveys the recording medium to the registration roller 38. The registration roller 38 is a pair of roller members disposed in pressure-contact with each other, and feeds to the transfer nip area the recording medium fed from the conveying roller 37 in synchronization with the conveyance of the toner image carried on the intermediate transfer belt 25 to the transfer nip area. The manual paper feed tray 39 is an apparatus for taking the recording medium into the image forming apparatus 1 by manual performance. The recording medium taken in from the manual paper feed tray 39 passes through a paper conveyance path S2 by use of the conveying roller 37, thereby being fed to the registration roller 38. In the recording medium supplying section 5, the recording medium supplied sheet by sheet from the automatic paper feed tray 35 or the manual paper feed tray 39 is fed to the transfer nip area in synchronization with the conveyance of the toner image carried on the intermediate transfer belt 25 to the transfer nip area.

The discharging section 6 includes the conveying roller 37, a discharging roller 40, and a catch tray 41. The conveying roller 37 is disposed downstream of the fixing nip area along the paper conveyance direction, and conveys toward the discharging roller 40 the recording medium onto which the image has been fixed by the fixing section 4. The discharging roller 40 discharges the recording medium onto which the image has been fixed, to the catch tray 41 disposed on a vertical direction-wise upper surface of the image forming apparatus 1. The catch tray 41 stores the recording medium onto which the image has been fixed.

The image forming apparatus 1 includes a control unit 50. The control unit 50 is disposed, for example, in an upper part of an internal space of the image forming apparatus 1, and contains a storage portion, a calculation portion, and a control portion. To the storage portion of the control unit 50 are input, for example, various set values obtained by way of an operation panel (not shown) disposed on the upper surface of the image forming apparatus, results detected from a sensor (not shown) etc. disposed in various portions inside the image forming apparatus 1, and image information obtained from an external equipment. Further, programs for operating various functional elements are written. Examples of the various functional elements include a recording medium determining portion, an attached amount control unit, and a fixing condition control unit. For the storage portion, those customarily used in the relevant filed can be used including, for example, a read only memory (ROM), a random access memory (RAM), and a hard disc drive (HDD). For the external equipment, it is possible to use electrical and electronic apparatuses which can form or obtain the image information and which can be electrically connected to the image forming apparatus 1. Examples of the external equipment include a computer, a digital camera, a television, a video recorder, a DVD (digital versatile disc) recorder, an HD-DVD (high-definition digital versatile disc), a blu-ray disc recorder, a facsimile machine, and a mobile apparatus.

The calculation portion of the control unit 50 takes out the various data (such as an image formation order, the detected result, and the image information) written in the storage portion and the programs for various functional elements, and then makes various determinations. The control portion of the control unit 50 sends to a relevant apparatus a control signal in accordance the result determined by the calculation portion, thus performing control on operations. The control portion and the calculation portion include a processing circuit which is achieved by a microcomputer, a microprocessor, etc. having CPU (central processing unit). The control unit 50 contains a main power source as well as the above-stated processing circuit. The power source supplies electricity to not only the control unit 50 but also respective apparatuses provided inside the image forming apparatus 1.

As the toner, two-component developer, developing apparatus 14, and image forming apparatus 1 of the invention are used to form images, it is possible to form high-quality images over a long period of time which images exhibit favorable fixing properties.

### EXAMPLE

Hereinafter, the invention will be described more in detail with reference to Examples and Comparative examples. In the following descriptions, “part” indicates “part by weight”, and “%” indicates “% by weight”, unless otherwise specified. The processes on how to determine data shown in Examples and Comparative examples will be described hereinbelow. The data are specifically the average particle size A of the protrusion, the average particle size B of the core particles, a coefficient of variation (CV value), and the volume average particle size of fine resin particles before fusion. The following descriptions will be directed also to the processes on how to determine a glass transition temperature (Tg) and a softening temperature (Tm) of the binder resin used in Examples and Comparative examples, and a melting point of the release agent used in Examples and Comparative examples.

(Measurement of Average Particle Size A of Protrusion)

A toner having a coating layer was photographed at 10,000-fold magnification by an electron microscope: VE-9800 (trade name) manufactured by Keyence Corporation. In an electron micrograph of the toner, a protrusions was selected which was contained in a circle with radius 1.5 μm (which appear as 1.5 cm in the micrograph of the toner) centered in the toner and which existed within the toner. A minor axis A1 and a major axis A2 of the protrusion were measured. An average value of the minor axis A1 and the major axis A2, that is, (A1+A2)/2 was then determined as an average particle size A of the protrusion.

(Measurement of Average Particles Diameter B of Core Particles and Coefficient of Variation (CV Value)

The core particles were photographed at 5,000-fold magnification by the above-specified electron microscope. From an electron micrograph thus obtained, a minor axis B1 and a major axis B2 were measured and an average value of the minor axis B1 and the major axis B2, that is, (B1+B2)/2 was determined as an average particle size B of the core particles. Moreover, on the basis of the determined average particle size B of the core particles and a standard deviation thereof, a coefficient of variation was calculated in the following formula.

Coefficient of variation=Standard deviation/Average particle size B of core particles

(Volume Average Particle Size)

To 50 ml of electrolyte: ISOTON II (trade name) manufactured by Beckman Coulter, Inc. were added 20 mg of a sample and 1 ml of alkyl ether sulfuric ester sodium, which were then subjected to a dispersion treatment at ultrasonic frequency of 20 kHz for three minutes, thereby preparing a measurement sample. The measurement sample was analyzed by a particle size distribution-measuring apparatus: Multisizer 3 (trade name) manufactured by Beckman Coulter, Inc. under the conditions that an aperture diameter was 100 μm and the number of particles for measurement was 50,000 counts. A volume particle size distribution of the sample particles was thus obtained from which the volume average particle size was then determined. Moreover, on the basis of the determined volume average particle size and a standard deviation thereof, a coefficient of variation of the toner was calculated in the following formula.

Coefficient of variation=Standard deviation/Volume average particle size

(Glass Transition Temperature (Tg) of Binder Resin)

Using a differential scanning calorimeter: DSC220 (trade name) manufactured by Seiko Electronics Inc., 1 g of a sample was heated at a temperature of which increase rate was 10° C./min based on Japanese Industrial Standards (JIS) K7121-1987, thus obtaining a DSC curve. A straight line was drawn toward a low-temperature side extendedly from a base line on the high-temperature side of an endothermic peak corresponding to glass transition of the DSC curve which had been obtained as above. A tangent line was also drawn at a point where a gradient thereof was maximum against a curve extending from a rising part to a top of the peak. A temperature at an intersection of the straight line and the tangent line was determined as the glass transition temperature (Tg).

(Softening Temperature (Tm) of Binder Resin)

An apparatus for evaluating flow characteristics: Flow tester CFT-100C (trade name) manufactured by Shimadzu Corporation, was set so that 1 g of a sample would be pushed out of a die (1 mm in nozzle aperture and 1 mm in length) under load of 10 kgf/cm² (9.8×10⁵ Pa). Using the apparatus, the sample was heated at a temperature of which increase rate was 6° C./min, and a temperature of the sample at the time when a half of the sample had flowed out of the die was determined as the softening temperature (Tm).

(Melting Point of Release Agent)

Using the differential scanning calorimeter: DSC220 (trade name) manufactured by Seiko Electronics Inc., 1 g of a sample was heated from a temperature of 20° C. up to 200° C. at a temperature of which increase rate was 10° C./min, and then an operation of rapidly cooling down the sample from 200° C. to 20° C. was repeated twice, thus obtaining a DSC curve. A temperature obtained at a top of an endothermic peak which corresponds to the melting shown on the DSC curve obtained at the second operation, was determined as the melting point of the release agent.

### Example 1

### Step of Fabricating Core Particles

Raw material monomers were synthesized with the aid of catalyst to obtain polyester resin. The raw material monomers were specifically 400 parts of polyoxypropylene(2.0)-2,2-bis(4-hydroxyphenyl)propane, 380 parts of polyoxyethylene(2.0)-2,2-bis(4-hydroxyphenyl)propane, and 330 parts of terephthalic acid. The catalyst was specifically 3 parts of dibutyltin oxide. The polyester resin thus obtained had a glass transition temperature (Tg) of 64° C. and a softening temperature (Tm) of 95° C. And then, as a colorant, copper phthalocyanine (C.I. pigment blue 15:3) was added to the polyester resin. A thus-obtained material was melt-kneaded for 40 minutes by a kneader set at 140° C. As a result, a master batch was obtained which contains 40% by weight of the colorant. Note that polyoxypropylene(2.0)-2,2-bis(4-hydroxyphenyl)propane is an adduct in which 2.0 mol of propylene oxide is added on average to 1.0 mol of 2,2-bis(4-hydroxyphenyl)propane, and polyoxyethylene(2.0)-2,2-bis(4-hydroxyphenyl)propane is an adduct in which 2.0 mol of ethylene oxide is added on average to 1.0 mol of 2,2-bis(4-hydroxyphenyl)propane.

Next, the following materials were mixed and dispersed by a Henschel mixer for three minutes: 77.5 parts of polyester resin which was the same as that used for the master batch; 12.5 parts of the master batch fabricated as above; 8 parts of a release agent, i.e. carnauba wax; and 2 parts of a charge control agent, i.e. Bontron E-84 manufactured by Orient Chemical Industries, Ltd. Note that the polyester resin has a glass transition temperature (Tg) of 64° C. and a softening temperature (Tm) of 95° C. A raw material was thus obtained. Using a twin-screw extruder:PCM-30 (trade name) manufactured by Ikegai Co., the raw material was then melt-kneaded and dispersed, resulting in a resin kneaded material. Note that operating conditions of the twin-screw extruder were set as follows: a temperature of cylinder was set at 110° C.; a barrel rotational speed was 300 rotations per minute (300 rpm); and a raw material-feeding speed was 20 kg/h. A toner kneaded material thus obtained was then cooled down by a cooling belt and coarsely pulverized by a speed mill having a screen which was 2 mm in opening diameter.

A coarsely-pulverized material thus obtained was then pulverized by an I-type jet mill and furthermore cleared of dust-size particles and coarse particles by using an elbow jet classifier, resulting in core particles C which exhibited an average particle size B of 6.9 μm and a coefficient of variation of 22.

(Step of Preparing Fine Resin Particles and Adhering Aid)

Fine particles of styrene-methyl methacrylate copolymer were prepared which had a volume average particle size of 0.4 μm. To be specific, the fine particles were MP-5000 (trade name) manufactured by Soken Chemical & Engineering Co., Ltd., which had a glass transition temperature (Tg) of 102° C. Moreover, as an adhering aid, ethanol was prepared.

(Step of Coating)

Into a surface-modifying apparatus having a container in which a two-fluid nozzle for atomizing liquid was provided, 100 parts of the core particles C and 5 parts of the fine resin particles were put and left for 10 minutes at a rotational speed of 8,000 rpm. Note that the surface-modifying apparatus was specifically the Hybridization system NHS-1 manufactured by Nara Machinery Co., Ltd. Subsequently, the surface-modifying nozzle was adjusted so that compressed air was fed to the two-fluid nozzle to atomize ethanol, which served as the adhering aid, at a rate of 0.5 g/min. The atomization then continued for 40 minutes, thereby coating the entire surfaces of the core particles with the fine resin particles.

The above coating formed of the fine resin particles became coating layers which cover the entire surfaces of the core particles. The core particles thus obtained were freeze-dried, resulting in a toner of Example 1. The toner of Example 1 had a volume average particle size of 7.3 μm and a coefficient of variation of 25.

### Example 2

A toner of Example 2 was obtained in the same manner as Example 1 except that the step of preparing the fine resin particles and the adhering aid and the step of coating were modified as follows. The toner of Example 2 had a volume average particle size of 7.3 μm and a coefficient of variation of 26.

(Step of Preparing Fine Resin Particles and Adhering Aid)

Using a homogenizer: Polytron PT-MR3100 (trade name) manufactured by Kinematica Inc., 20 parts of fine particles of styrene-methyl methacrylate copolymer having a volume average particle size of 0.4 μm and 80 parts of ethanol serving as the adhering aid were mixed with each other by agitation at a rotational speed of 8,000 rpm for 20 minutes, thereby preparing a coating solution which contains 20% by weight of the fine resin particles having a volume average particle size of 0.4 μm. To be specific, the fine particles of styrene-methyl methacrylate copolymer were MP-5000 (trade name) manufactured by Soken Chemical & Engineering Co., Ltd., which had a glass transition temperature (Tg) of 102° C. Note that the quantity of both ingredients was based on solid contents thereof.

(Step of Coating)

Into a surface-modifying apparatus having a container in which a two-fluid nozzle for atomizing liquid was provided, 100 parts of the core particles C was put and left at a rotational speed of 8,000 rpm. Note that the surface-modifying apparatus was specifically the Hybridization system NHS-1 manufactured by Nara Machinery Co., Ltd. The surface-modifying nozzle was adjusted so that compressed air was fed to the two-fluid nozzle to atomize a coating solution that was a mixture of 20 parts of the fine resin particles and 80 parts of ethanol at a rate of 0.5 g/min during the retention of the core particles C. The atomization then continued for 50 minutes, thereby coating the entire surfaces of the core particles with the fine resin particles. Note that the quantity of ethanol was based on a solid content thereof.

### Example 3

A toner of Example 3 was obtained in the same manner as Example 1 except that the used fine resin particles were fine resin particles of styrene-methyl methacrylate copolymer having a volume average particle size of 0.2 μm and a glass transition temperature (Tg) of 102° C., which had been obtained by polymerizing styrene and methyl methacrylate. The toner of Example 3 had a volume average particle size of 7.1 μm and a coefficient of variation of 25.

### Example 4

A toner of Example 4 was obtained in the same manner as Example 1 except that the used fine resin particles were fine resin particles of methyl methacrylate polymer: MP-1451 (trade name) manufactured by Soken Chemical & Engineering Co., Ltd., which had a volume average particle size of 0.15 μm and a glass transition temperature (Tg) of 128° C. The toner of Example 4 had a volume average particle size of 7.0 μm and a coefficient of variation of 25.

### Example 5

A toner of Example 5 was obtained in the same manner as Example 1 except that the following points were modified. The toner of Example 5 had a volume average particle size of 7.2 μm and a coefficient of variation of 24.

<Step of Fabricating Core Particles>

Raw materials were 790 parts of 1,4-butanediol, 440 parts of 1,6-hexanediol, 1,500 parts of fumaric acid, 1 part of hydroquinone, and 2 parts of dibutyltin oxide. Crystalline polyester resin E was obtained by the reaction of these raw materials. The crystalline polyester resin E had a softening temperature of 110° C. and heat of melting whose highest peak temperature was 111° C., with a number average molecular weight of 4,200 and a weight average molecular weight of 72,000.

Core particles D having an average particle size B of 6.9 μm and a coefficient of variation of 22 were obtained in the same manner as the core particles C except using 10 parts of the crystalline polyester resin E, 67.5 parts of the above polyester resin, 12.5 parts of the master batch, 8 parts of the release agent, and 2 parts of the charge control agent.

### Example 6

A toner of Example 6 was obtained in the same manner as Example 5 except that the used fine resin particles were fine particles of styrene-butyl acrylate copolymer having a volume average particle size of 0.1 μm and a glass transition temperature (Tg) of 80° C. The toner of Example 6 had a volume average particle size of 7.0 μm and a coefficient of variation of 24.

### Comparative Example 1

A toner of Comparative example 1 was obtained in the same manner as Example 1 except that the step of coating was modified as follows. The toner of Comparative example 1 had a volume average particle size of 7.0 μm and a coefficient of variation of 26. In the toner of Comparative example 1, some of the fine resin particles were desorbed.

(Step of Coating)

Into the surface-modifying apparatus: Hybridization system NHS-1 manufactured by Nara Machinery Co., Ltd., 100 parts of the core particles and 5 parts of the fine resin particles were put and left for 10 minutes at a rotational speed of 8,000 rpm, thereby attaching the fine resin particles to the core particles without atomizing ethanol.

### Comparative Example 2

A toner of Comparative example 2 was obtained in the same manner as Example 1 except that the used fine resin particles were particles having a volume average particle size of 1.0 μm and a glass transition temperature (Tg) of 128° C., which had been obtained by polymerizing methyl methacrylate. The toner of Comparative example 2 had a volume average particle size of 7.0 μm and a coefficient of variation of 30. In the toner of Comparative example 2, the fine resin particles were not fused to the core particles.

Table 1 shows property values, etc. of the toners of Examples and Comparative examples fabricated as above. Note that “particles” marked in the item “atomization” indicate the fine resin particles.

TABLE 1

| | | | Core particles | | Protrusions | | Toner | |
|---|---|---|---|---|---|---|---|---|
| | | | Average | | Average | | Volume average | |
| | | | particle size B | | particle size A | | particle size | |
| | Fine resin particles/particle size | Atomization | (μm) | CV | (μm) | A/B | (μm) | CV |
| Example 1 | Styrene-methyl methacrylate | Ethanol | (Core C) 6.9 | 22 | 0.7 | 0.10 | 7.3 | 25 |
| | copolymer/0.4 μm | | | | | | | |
| Example 2 | Styrene-methyl methacrylate | Ethanol + | (Core C) 6.9 | 22 | 0.7 | 0.10 | 7.3 | 26 |
| | copolymer/0.4 μm | particles | | | | | | |
| Example 3 | Styrene-methyl methacrylate | Ethanol | (Core C) 6.9 | 22 | 0.35 | 0.05 | 7.1 | 25 |
| | copolymer/0.2 μm | | | | | | | |
| Example 4 | Methyl methacrylate | Ethanol | (Core C) 6.9 | 22 | 0.2 | 0.03 | 7.0 | 25 |
| | copolymer/0.15 μm | | | | | | | |
| Example 5 | Styrene-methyl methacrylate | Ethanol | (Core D) 6.9 | 22 | 0.7 | 0.10 | 7.2 | 24 |
| | copolymer/0.4 μm | | | | | | | |
| Example 6 | Styrene-butyl acrylate | Ethanol | (Core D) 6.9 | 22 | 0.2 | 0.02 | 7.0 | 24 |
| | copolymer/0.1 μm | | | | | | | |
| Comparative | Styrene-methyl methacrylate | — | (Core C) 6.9 | 22 | 0.4 | 0.06 | 7.0 | 26 |
| Example 1 | copolymer/0.4 μm | | | | | | | |
| Comparative | Methyl methacrylate | Ethanol | (Core C) 6.9 | 22 | 1 | 0.14 | 7.0 | 30 |
| Example 2 | copolymer/1.0 μm | | | | | | | |

The storage stability of the toners of Examples and Comparative examples was evaluated as follows.

(Evaluation of Storage Stability)

In a plastic container, 100 g of the toner was put and sealed, thereafter being left for 48 hours at 50° C. Subsequently, the toner was taken out of the container and screened out through a 100-mesh sieve. The toner remained on the sieve was weighed, and a proportion of a weight thus obtained to a total weight of the toner was calculated as a residual amount. The residual amount was evaluated based on the following criteria. The smaller figure indicates the less frequency of blocking of the toner, that is to say, the better storage stability.

Good: the residual amount was less than 10%.

Poor: the residual amount was 10% or more.

With 100 parts of the toners of Examples and Comparative examples obtained as described above, 0.7 part of silica particles and 1 part of titanium oxide were mixed. Note that the silica particles had been hydrophobically treated with a silane coupling agent and had an average primary particle size of 20 nm. The toner thus obtained is now referred to as externally-additive toner. The externally-additive toner was then mixed with a ferrite core carrier having a volume average particle size of 60 μm in such an adjusted proportion that a concentration of the externally-additive toner would become 7% by weight, thereby fabricating a two-component developer which had a toner concentration of 7% by weight. The two-component developer thus obtained was then used to form an image for evaluation as follows, and the following items were evaluated on the image for evaluation.

(Formation of Image for Evaluation)

The obtained two-component developer was put in a developing apparatus installed in a test printer which had been obtained by removing a fixing apparatus from a commercially-available printer: LIBRE AR-S505 (trade name) manufactured by Sharp Corporation. By using the test printer, a solid image part was formed, though not fixed, on an A4-sized recording sheet defined by Japanese Industrial Standards (JIS) P0138, with use of a toner of which amount attached thereto was adjusted to 0.6 mg/cm². The solid image part had a rectangular shape which is 20 mm long by 50 mm wide. The yet-fixed toner image thus formed was then fixed by an external fixing machine onto the recording sheet which was fed at a speed of 120 mm/sec, thereby forming an image for evaluation. As the external fixing machine, an oil-less fixing apparatus was taken out of a commercially-available full-color copier: LIBRE AR-C260 (trade name) manufactured by Sharp Corporation, and adapted so that a surface temperature of a heating roller can be set at a given degree. The oil-less fixing apparatus herein means a fixing apparatus which performs the fixing operation by a heating roller not coated with a release agent such as silicone oil.

(Evaluation of High-Temperature Offset Resistance)

The formed image for evaluation was observed and checked with eyes whether or not the toner image was transferred from the heating roller onto a white background part of the recording sheet which part should be a blank. It was thus determined whether or not the high-temperature offset phenomenon appeared. This operation was repeated with the surface temperature of the heating roller sequentially rising by 5° C. from 130° C. to 220° C. By so doing, obtained was the highest surface temperature of the heating roller in the range where the high-temperature offset phenomenon did not appear. The highest surface temperature will be hereinafter referred to as maximum fixing temperature. The high-temperature offset resistance was evaluated based on the following criteria.

Good: the maximum fixing temperature was 200° C. or higher.

Poor: the maximum fixing temperature was lower than 200° C.

(Evaluation of Non-Offset Region)

As in the case of the evaluation of high-temperature offset resistance, images were formed by using the heating roller whose surface temperature was sequentially rising by 5° C. from 130° C. to 220° C. By so doing, the offset resistance was evaluated by locating the non-offset region where neither of the phenomena arose: the low-temperature offset phenomenon that no toner image was fixed onto the recording sheet; or the high-temperature offset phenomenon that a toner image was transferred from the heating roller onto the white background part of the recording sheet which part should be a blank. The non-offset region is determined from a difference in temperature between a minimum fixing temperature (° C.) that is the lowest temperature of the heating roller at which the low-temperature offset phenomenon does not appear and a maximum fixing temperature (° C.) that is the highest temperature of the heating roller at which the high-temperature offset phenomenon does not appear. The non-offset region was evaluated based on the following criteria.

Good: the non-offset region ranges over a temperature equal to 25° C. and more.

Poor: the non-offset region ranges below a temperature less than 25° C.

(Image Density)

A reflection densitometer: RD918 (trade name) manufactured by Macbeth Co. was used to measure optical reflection density of a solid image part in an image formed by using the heating roller whose surface temperature was 170° C. Density thus obtained was defined as image density. The image density was evaluated based on the following criteria.

Good: the image density was 1.40 or more.

Poor: the image density was less than 1.40.

(Cleaning Property)

In the manner as above, charts were continuously printed on 1,000 sheets. The charts were 5% in print ratio. The surface of the photoreceptor was then checked with eyes whether or not the toner filming appeared thereon. The cleaning property was evaluated based on the following criteria.

Good: no toner filming appeared.

Poor: some toner filming appeared.

(Comprehensive Evaluation)

A comprehensive evaluation was conducted based on the following criteria by combining the above results of the storage stability, the evaluation of high-temperature offset resistance, the evaluation of non-offset region, the evaluation of image density, and the cleaning property.

Good: “Poor” was not given in any of the evaluation items.

Poor: “Poor” was given in any of evaluation items.

Table 2 shows the evaluation results mentioned above.

TABLE 2

| | Storage stability | | | | | |
|---|---|---|---|---|---|---|
| | Residual | | Fixing temperature (° C.) | | | Evaluation for |
| | amount | | Min. | Max. | Non-offset | high-temperature |
| | (%) | Evaluation | Temp. | Temp. | region | offset resistance |
| Example 1 | 6 | Good | 175 | 200 | 25 | Good |
| Example 2 | 6 | Good | 175 | 200 | 25 | Good |
| Example 3 | 7 | Good | 175 | 200 | 25 | Good |
| Example 4 | 5 | Good | 175 | 200 | 25 | Good |
| Example 5 | 6 | Good | 175 | 200 | 25 | Good |
| Example 6 | 8 | Good | 160 | 200 | 40 | Good |
| Comparative | 15 | Poor | 165 | 190 | 25 | Poor |
| Example 1 | | | | | | |
| Comparative | 22 | Poor | 160 | 190 | 30 | Poor |
| Example 2 | | | | | | |

| | Evaluation | | | | |
|---|---|---|---|---|---|
| | for | | | | |
| | non-offset | Image density | | Cleaning | Comprehensive |
| | region | Measurement | Evaluation | property | evaluation |
| Example 1 | Good | 1.4 | Good | Good | Good |
| Example 2 | Good | 1.4 | Good | Good | Good |
| Example 3 | Good | 1.4 | Good | Good | Good |
| Example 4 | Good | 1.4 | Good | Good | Good |
| Example 5 | Good | 1.4 | Good | Good | Good |
| Example 6 | Good | 1.4 | Good | Good | Good |
| Comparative | Good | 1.4 | Good | Poor | Poor |
| Example 1 | | | | | |
| Comparative | Good | 1.4 | Good | Poor | Poor |
| Example 2 | | | | | |

As shown in Table 2, the toners of Examples 1 to 6, i.e. the toners of the invention were excellent in the storage stability, the high-temperature offset resistance, and the cleaning property as compared to the toners of Comparative examples 1 and 2.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. A toner comprising:
a core particle containing a binder resin and a colorant; and
a coating layer formed on a surface of the core particle, containing fine resin particles, the fine resin particles being partially fused to at least either the core particle or adjacent fine resin particles.

2. The toner of claim 1, wherein a ratio of a surface area of the core particle where the coating layer is formed is 80% to 100% of an entire surface area of the core particle.

3. The toner of claim 1, wherein a ratio A/B is 0.01 to 0.2 where A represents an average particle size of fused fine resin particles contained in the coating layer and B represents an average particle size of the core particle.

4. The toner of claim 1, wherein the fine resin particles include acrylic resin, styrene-acryl copolymer resin, or polyester resin.

5. The toner of claim 1, wherein the core particle includes a binder resin containing at least crystalline polyester resin and amorphous polyester resin, a colorant, and a release agent.

6. A method of manufacturing the toner of claim 1, the method comprising:
bringing the core particle and fine resin particles into contact with each other in a presence of an adhering aid for increasing adherence between the core particle and the fine resin particles.

7. The method of claim 6, wherein a volume average particle size of fine resin particles before fusion is 0.05 μm to 0.5 μm.

8. The method of claim 6, wherein the adhering aid includes water or lower alcohol.

9. The method of claim 6, wherein the fine resin particles are used at a ratio of 1 part by weight to 30 parts by weight based on 100 parts by weight of the core particles.

10. The method of claim 6, wherein the fine resin particles are attached and fused to the core particle by a surface-modifying apparatus which comprises: a container for housing the core particle and the fine resin particles; an atomizer for atomizing the adhering aid into the container; and an agitator for agitating the core particle inside the container.

11. The method of claim 6, wherein the fine resin particles are attached and fused to the core particles by a surface-modifying apparatus which comprises: a container for housing the core particle; an atomizer for atomizing a mixture of the fine resin particles and the adhering aid into the container; and an agitator for agitating the core particles inside the container.

12. The method of claim 11, wherein the adhering aid is used at a ratio of 1 part by weight to 99 parts by weight based on 1 part by weight of the fine resin particles.

13. The method of claim 10, wherein a temperature inside the container is less than a glass transition temperature of the binder resin contained in the core particle.

14. The method of claim 11, wherein a temperature inside the container is less than a glass transition temperature of the binder resin contained in the core particle.

15. The method of claim 10, wherein the adhering aid is atomized in a state where the core particle is suspended inside the container.

16. The method of claim 11, wherein the adhering aid is atomized in a state where the core particle is suspended inside the container.

17. A two-component developer comprising the toner of claim 1 and a carrier.

18. A developing apparatus which perform a developing operation with use of the two-component developer of claim 17.

19. An image forming apparatus comprising the developing apparatus of claim 18.
